(19) United States
(12) Patent Application Publication
(10) Pub. No.: US 2023/0042201 A1
(43) Pub. Date: Feb. 9, 2023

(54) QUANTUM COMPUTER ARCHITECTURE BASED ON SILICON DONOR QUBITS COUPLED BY PHOTONS

(71) Applicant: THE UNIVERSITY OF BRITISH COLUMBIA, Vancouver (CA)

(72) Inventors: Robert RAUSSENDORF, Vancouver (CA); Xiruo YAN, Vancouver (CA); Jingda WU, Vancouver (CA); Jeffrey YOUNG, Vancouver (CA); Warit ASAVANANT, Tokyo (JP)

(21) Appl. No.: 17/758,493

(22) PCT Filed: Jan. 8, 2021
(86) PCT No.: PCT/CA2021/050015

§ 371 Date: Jul. 7, 2022

Related U.S. Application Data
(60) Provisional application No. 62/959,362, filed on Jan. 10, 2020.

(51) Int. Cl. G06N 10/40; G06E 1/00

(52) U.S. Cl. CPC G06N 10/40; G06E 1/00

(57) ABSTRACT

An architecture for fault-tolerant universal quantum computation is suited for matter qubits, such as donor qubits in silicon, coupled by a network of photonic interconnects. The basic operational building blocks are local measurements and unitaries, plus an entangling measurement of non-local Pauli operators. 3D graph states created by applying deterministic entangling measurements to pairs of qubits in knitting and fusion processes to yield resource states for one way computing. The deterministic entangling measurements are facilitated by configuring the network with active switches to allow single photons to interact with pairs of matter qubits.

### CROSS-REFERENCE TO RELATED APPLICATIONS

This application claims priority from U.S. application No. 62/959,362 filed 10 Jan. 2020 and entitled QUANTUM COMPUTER ARCHITECTURE BASED ON SILICON DONOR QUBITS COUPLED BY PHOTONS which is hereby incorporated herein by reference for all purposes. For purposes of the United States of America, this application claims the benefit under 35 U.S.C. § 119 of U.S. application No. 62/959,362 filed 10 Jan. 2020 and entitled QUANTUM COMPUTER ARCHITECTURE BASED ON SILICON DONOR QUBITS COUPLED BY PHOTONS.

### FIELD

The inventions described herein relate to quantum information processing. Example embodiments provide methods and systems for quantum data processing. The invention has particular application to quantum information processing based on quantum measurements.

### BACKGROUND

Quantum computing has the potential to perform computations must faster than conventional digital computers. The potential speedup of quantum computing relative to conventional digital computing increases with the size of the computation. A fundamental difference between quantum computers and conventional digital computers is the way that information is represented. In a conventional digital computer the basic unit of information is the “bit” which can be set to one of two values, typically identified as “1” or “0”. By contrast, the qubit, which is a basic unit of information in a quantum computer can be set to have a state which is a superposition of computational basis states corresponding to both possible values.

The infinite number of possible pure states available to a qubit can be represented as points on a sphere (the “Bloch sphere”). On the Bloch sphere the top of Bloch sphere represents a first computational basis state (e.g. |0 [symbol] ) and the bottom of Bloch sphere represents a second computational basis state (e.g. |1 [symbol] ). All other points on the surface of the Bloch sphere represent superpositions of these computational basis states (e.g. states of the form a|0 [symbol] +b|1 [symbol] where a and b are complex coefficients).

A problem with quantum computing is that qubits generally cannot maintain information indefinitely. This is a result of decoherence. Decoherence is a process that converts coherent superpositions of quantum states into probabilistic mixtures over time. The rate at which decoherence occurs for a particular qubit can be represented as a “decoherence time” which depends on the nature of the qubit and its environment. Qubits of different types have different characteristic decoherence times. Decoherence times of matter qubits can be increased by maintaining the matter qubits at very low temperatures (e.g. temperatures close to zero Kelvin).

The principal cause of decoherence is the inevitable and uncontrolled interaction of qubits with their surroundings. For example, where information is stored in a qubit by causing the qubit to be in a quantum superposition of two or more quantum basis states, some information is stored in the relative phases of the basis states. Decoherence changes the relative phases of the wave functions of the basis states; quantum information is thereby lost. Decoherence also reduces or eliminates quantum behaviours such as entanglement that are relied upon in quantum computing.

The effect of decoherence may be mitigated by using qubits that have long decoherence times and/or using schemes for fault tolerant computation (e.g. by encoding quantum information in the states of groups of qubits).

The speedup advantage of quantum computation relative to conventional digital computing arises in large computations for which maintaining quantum coherence is a formidable challenge.

Fortunately, arbitrarily long and accurate quantum computations are possible despite decoherence as long as the amount of decoherence introduced by each elementary gate operation is below a critical level, the “fault-tolerance threshold”. The fault tolerance threshold is independent of scale and depends on the fault-tolerance scheme employed, and the dominant modes of decoherence present in the physical system.

The quality criteria for any scheme of fault-tolerant quantum computation are (i) the value of the fault-tolerance threshold, and (ii) the operational overhead required to implement fault-tolerance. Predictions for error thresholds now reach into the low percent range. Examples of such predictions can be found in E. Knill, Nature (London) 434, 39 (2005) and A. G Fowler, A. M. Stephens, P. Groszkowski, Phys. Rev. A 80, 052312 (2009).

The operational cost of fault-tolerance scales poly-logarithmically. That is, if the number of quantum gates in a circuit with perfect gates is S, then the fault-tolerant version of the circuit will require ˜S (log S)^{γ} imperfect gates. The exponent γ is a property of the fault tolerant computational scheme. Operational cost may be reduced in the large size limit by selecting a fault tolerant scheme for which γ is smaller.

A class of fault tolerance schemes applies topological fault-tolerance. One example of a topological fault tolerant scheme is the Kitaev surface code (see e.g. A. Kitaev, Ann. Phys. (N.Y.) 303, 2 (2003) and E. Dennis, A. Kitaev, A. Landahl and J. Preskill, J. Math. Phys. (N.Y.) 43, 4452 (2002)). Fault-tolerant universal quantum computation with high fault tolerance threshold may apply topological codes such as Kitaev surface codes (see e.g. R. Raussendorf and J. Harrington, Phys. Rev. Lett. 98, 190504 (2007)).

Various general architectures for quantum computing hardware have been proposed. Different hardware platforms may use different quantum entities as qubits.

For example, platforms based on:
ion traps,
cold atoms,
superconducting circuits,
photons and
particle spins
   as qubits have all been proposed. Each of these choices has advantages and disadvantages.

Photons, for example, have the advantage of long decoherence times even at room temperature. Quantum information may be represented for example by photon polarization states. On the other hand, it is difficult to make photons interact (i.e., have the presence or absence of one photon affect the behavior of another), and unlike matter qubits, photons can escape from the information processing platform.

One approach to quantum computing involves using quantum gates to modify quantum states of one or more qubits. The modifications may for example, change relative phases rotate a vector representing a quantum state of a qubit around an axis in the Bloch sphere. Quantum gates can be represented mathematically as unitary transformations. An example physical implementation of a quantum gate uses microwave or radiofrequency pulses of selected frequencies and durations to alter the quantum state of a spin (such as an electron spin or a nuclear spin). An example of a quantum gate is the Hadamard gate which is described below. Some quantum gates operate on two or more qubits. An example of a quantum gate that operates on two qubits is the CNOT gate. Gate based quantum computing typically involves preparing one or more qubits in a desired initial state and then applying a sequence of quantum gates to the qubits to cause one or more of the qubits to have a quantum state corresponding to a result of the quantum computation.

“One way” or “measurement based” quantum computing is a promising alternative to gate based quantum computation. One way quantum computing is described, for example, in R Raussendorf, et al. New Journal of Physics 9 (2007) 199 and in Daniel E. Browne et al. arXiv:quant-ph/0603226v2.

One way quantum computing involves preparing a resource state that includes a plurality of qubits that are entangled with one another. The resource state may, for example comprise a quantum cluster state or a quantum graph state. A three-dimensional cluster state can support universal and fault-tolerant quantum computation (see R. Raussendorf, J. Harrington, K. Goyal, Ann. Physics 321, 2242 (2006)). Cluster states are described for example in H. J. Briegel and R. Raussendorf, Phys. Rev. Lett. 86, 910 (2001).

One way quantum computing involves making quantum measurements on the qubits of a resource state. By selecting a sequence of appropriate measurements in appropriate bases, it is possible to execute quantum computing algorithms. Where the resource state is a 3D quantum cluster state, the one way computing may implement fault tolerance using topological codes.

R. Raussendorf, J. Harrington, K. Goyal, Ann. Phys. (N.Y.) 321, 2242 (2006) provides an example in which a 3D cluster state is implemented with two spatial dimensions and one time dimension. By arranging qubits in a double-layer 2D structure which includes two layers (A and B) instead of a single layer structure, all qubits within one layer may be read out simultaneously. This reference describes a cycle of operation that consists of the steps:

(i) Ising interaction within the layers A and B;
(ii) Ising interaction between the two layers;
(iii) local measurement of all qubits in layer A, with subsequent re-preparation of these qubits in the state |+ [symbol] (leaving the qubits in layer B alone);
(iv) Ising interaction between the two layers;
(v) local measurement of all qubits in layer B, with subsequent re-preparation of these qubits in the state |+ [symbol] .

While there have been many theoretical developments in the field of quantum computing, there remains a need for practical quantum computers that are technically achievable. There is a particular need for quantum computers capable of performing fault tolerant one way computing.

### SUMMARY

The present invention has several aspects. These include, without limitation:
quantum computing apparatus;
quantum computing methods;
methods for creating quantum cluster states;
optical networks for quantum computing;
control systems for measurement based quantum computers.

One aspect of the invention provides a method for performing quantum computations. The method comprises creating a 3D quantum graph state in a plurality of matter qubits arranged in a two-dimensional pattern on a substrate and connected by a network of photonic links. Each of the matter qubits has first and second quantum computational basis states. The method further comprises performing quantum computations on the 3D graph state by measuring some or all of the matter qubits in corresponding selectable specified bases. The 3D graph state has a connected three-dimensional graph structure comprising plural vertices each associated with a corresponding qubit, the vertices connected by plural edges which indicate a structure of entanglement of the 3D graph state, each of the edges extending between a pair of the vertices. The 3D graph state comprises a plurality of 2D slices in an order from a first one of the 2D slices to a last one of the 2D slices. Each of the 2D slices comprises a plurality of the vertices and a plurality of the edges that are intraslice edges that connect vertices within the 2D slice in a 2D graph structure. The edges of the 3D graph state include interslice edges that interconnect different ones of the 2D slices such that each of the 2D slices is connected by one or more of the interslice edges to one or more other ones of the 2D slices. The method comprises configuring the matter qubits to provide a plurality of subsequent ones of the 2D slices, each of the plurality of subsequent ones of the 2D slices provided by a corresponding set of the matter qubits wherein: configuring the matter qubits comprises entangling quantum states of matter qubits that correspond to vertices of the plurality of 2D slices that are connected by corresponding edges of the 3D cluster state by one or more steps comprising performing deterministic entangling parity measurements on pairs of the matter qubits; and, performing each of the deterministic entangling parity measurements comprises: configuring the network of photonic links so that each of the matter qubits in the one of the pairs of matter qubits corresponding to the deterministic parity measurement is coupled between first and second ones of the photonic links; injecting a photon into the first photonic link; and detecting the injected photon in the first photonic link or the second photonic link.

In some embodiments the 3D graph state is a 3D cluster state.

In some embodiments measuring some or all of the matter qubits in corresponding selectable specified bases is performed at different times for different ones of the 2D slices.

In some embodiments performing the quantum computations comprises measuring some or all of the matter qubits configured as one of the plurality of 2D slices that is earlier in the order and subsequently reconfiguring those matter qubits to provide one of the 2D slices that is later in the order.

In some embodiments the method comprises simultaneously measuring a plurality of the qubits of the set of matter qubits configured as the one of the plurality of 2D slices that is earlier in the order.

In some embodiments in the three-dimensional graph structure, at least one of the 2D slices comprises a first plurality of the edges connecting a first plurality of the vertices to form a first two dimensional cyclic graph having at least one closed cycle and another one of the 2D slices adjacent to the one of the 2D slices comprises a second plurality of the edges connecting a second plurality of the vertices to form a second two dimensional cyclic graph having at least one closed cycle.

In some embodiments the three-dimensional graph structure is a face centered cubic structure.

In some embodiments the three-dimensional graph structure is a body centered cubic structure.

In some embodiments performing the deterministic entangling parity measurements comprises measuring the observable Zₐ⊗Z_{b} where Zₐ is the Pauli Z observable of a first one of the pair of matter qubits associated with the deterministic entangling parity measurement and Z_{b} is the Pauli Z observable of a second one of the pair of matter qubits associated with the pair of matter qubits associated with the deterministic entangling parity measurement.

In some embodiments the network of photonic links comprises a plurality of optical switches. Configuring the network of photonic links comprises setting the optical switches to optically isolate sections of the first and second ones of the photonic links that are coupled to the matter qubits in the one of the pairs from other ones of the matter qubits.

In some embodiments the network of photonic links comprises one single photon source and first and second single photon detectors associated with each one of the matter qubits. Injecting a photon into the first photonic link comprises operating the single photon source that is associated with a first one of the pair of the matter qubits. Detecting the injected photon in the first photonic link or the second photonic link comprises detecting the injected photon at the first single photon detector or the second single photon detector associated with a second one of the pair of the matter qubits.

In some embodiments the matter qubits are arranged in a first plane and one or more of the single photon sources or one or more of the single photon detectors are arranged out of the first plane (e.g. in a second plane that is spaced apart from the first plane).

In some embodiments each of the matter qubits is coupled to an optical cavity having a resonant frequency corresponding to a characteristic energy associated with a dipole-allowed transition from one of the first and second quantum states of the matter qubit to a higher-energy excited state of the matter qubit and the optical cavity is coupled between two of the photonic links and the single photon has a frequency substantially equal to the resonant frequency.

In some embodiments the characteristic energy corresponds to a frequency on the order of 100 THz.

In some embodiments the first and second computational basis states have an energy difference corresponding to a frequency on the order of 2 GHz.

In some embodiments each of the matter qubits is coupled to an optical cavity having a resonant frequency corresponding to a characteristic energy associated with a dipole-allowed transition from one of the first and second quantum states of the matter qubit to a higher-energy excited state of the matter qubit and the optical cavity is coupled between two of the photonic links.

In some embodiments configuring the matter qubits to provide a plurality of adjacent ones of the 2D slices comprises configuring the matter qubits to provide a plurality of 2D quantum graph states and generating edges that join vertices of the 2D quantum graph states.

In some embodiments each of the 2D quantum graph states is tree-like.

In some embodiments the 2D quantum graph states each have the same graph structure.

In some embodiments the 2D quantum graph states each comprises a graph consisting of a vertex with four 1D branches extending from the vertex.

In some embodiments two of the four 1D branches have one vertex each and two of the four 1D branches have two vertexes each.

In some embodiments each of the 2D quantum graph states has a 2D tree-like graph structure and the method comprises: initializing a quantum state of one of the matter qubits corresponding to an initial vertex of one of the quantum graph states; and sequentially adding vertices to complete the 2D tree-like graph structure of the 2D quantum graph state by, for each of the added vertices: preparing a corresponding one of the matter qubits that is not already included in any of the 2D quantum graph states in the state |+ [symbol] , where |+ [symbol] is the eigenstate of the Pauli operator X with the eigenvalue+1; measuring the correlated observable Zₙ⊗Zₙ₊₁ where Zₙ operates on one of the matter qubits corresponding to a vertex of the 2D tree-like graph structure under construction and Zₙ₊₁ operates on the matter qubit corresponding to the vertex being added and ⊗ is the tensor product; conditionally, if the measurement of the observable Zₙ⊗Zₙ₊₁ yields a value of −1, applying the Pauli operator Xₙ₊₁ to the matter qubit corresponding to the vertex being added; and applying a Hadamard gate Hₙ₊₁ to the matter qubit corresponding to the vertex being added.

In some embodiments generating at least one of the edges that joins one of the vertices of a first one of the 2D quantum graph states to one of the vertices of a second one of the 2D quantum graph states comprises fusing the first and second 2D graph states by: measuring the correlated observable Zₐ⊗Z_{b} where Zₐ is the Pauli Z operator that acts on the matter qubit corresponding to one vertex of the first 2D quantum graph state and Z_{b} is the Pauli Z operator that acts on the matter qubit corresponding to one vertex of the second 2D quantum graph state; and subsequently performing the measurement cos(α)Xa+sin(α)Ya or the measurement cos(α)Xb+sin(α)Yb where α is any angle, Xa is the Pauli X operator that acts on the matter qubit corresponding to one vertex of the first 2D quantum graph state and Xb is the Pauli X operator that acts on the matter qubit corresponding to one vertex of the second 2D quantum graph state; Ya is the Pauli Y operator that acts on the matter qubit corresponding to one vertex of the first 2D quantum graph state and Yb is the Pauli Y operator that acts on the matter qubit corresponding to one vertex of the second 2D quantum graph state.

In some embodiments the measurement is Xb.

In some embodiments each of the 2D quantum graph states comprises 5 to 20 vertices.

In some embodiments configuring the matter qubits to provide the plurality of 2D slices comprises: fusing a first plurality of 2D quantum graph states together to form a first 2D sheet; fusing a second plurality of the 2D quantum graph states together to form a second 2D sheet; and fusing the first 2D sheet and the second 2D sheet.

In some embodiments the method comprises simultaneously configuring the matter qubits to provide two or more of the plurality of 2D quantum graph states.

In some embodiments the plurality of 2D slices all have congruent graph structures.

In some embodiments at least some of the plurality of 2D slices comprises a polycyclic graph structure.

In some embodiments the matter qubits comprise donor qubits.

In some embodiments the donor qubits comprise impurity atoms implanted in the substrate.

In some embodiments the impurity atoms comprise ionized Se atoms.

In some embodiments the Se atoms are singly ionized and the matter qubits each comprise quantum information encoded in the ground state manifold of one of the singly ionized Se atoms.

In some embodiments the method comprises manipulating the qubit quantum states using a 2.9 μm resonant dipole transition to excited states of the singly ionized Se atoms.

In some embodiments the substrate is a silicon substrate.

In some embodiments at least a part of the substrate in which the matter qubits are located is enriched in one or more nuclear spin free stable isotopes of silicon.

In some embodiments at least a part of the substrate in which the matter qubits are located comprises or consists essentially of isotopically purified silicon-28, isotopically purified silicon-30 or a mixture thereof.

In some embodiments the substrate is a silicon on insulator substrate.

In some embodiments the method comprises cooling the substrate to a temperature of 4K or lower.

In some embodiments the set of matter qubits configured to provide each of the plurality of subsequent ones of the 2D slices forms a regular array on the substrate and the regular arrays corresponding to different ones of the plurality of subsequent ones of the 2D slices are offset relative to one another in a direction parallel to a plane of the substrate.

In some embodiments the plurality of subsequent ones of the 2D slices is made up of two of the 2D slices.

In some embodiments the matter qubits comprise first and second sets of the matter qubits and performing quantum computations on the 3D graph state comprises measuring some or all of the matter qubits of the first set of matter qubits in alternation with measuring some or all of the matter qubits of the second set of matter qubits.

In some embodiments the method comprises, after measuring some or all of the matter qubits of the first set of matter qubits: initializing the matter qubits of the first set of matter qubits; configuring the first set of matter qubits according to the 2D graph structure; and fusing the first set of matter qubits to the second set of matter qubits.

In some embodiments the method comprises, after measuring some or all of the matter qubits of the second set of matter qubits: initializing the matter qubits of the second set of matter qubits; configuring the second set of matter qubits according to the 2D graph structure; and fusing the second set of matter qubits to the first set of matter qubits.

Another aspect of the invention provides a quantum computing apparatus comprising: a plurality of matter qubits arranged in a two-dimensional pattern on a substrate and connected by a network of photonic links, each of the matter qubits having first and second quantum computational basis states; and means for measuring the matter qubits in corresponding selectable specified bases; wherein: the photonic network comprises: a plurality of single photon sources; a plurality of single photon detectors; and a plurality of optical switches operative to selectively connect or disconnect segments of the photonic links, for each of plural pairs of the mater qubits the optical switches are configurable to: provide a first photonic link segment coupled to each of the matter qubits of the pair and isolated from others of the matter qubits; provide a second photonic link segment that is coupled to each of the matter qubits of the pair and is isolated from others of the matter qubits; couple one of the single photon sources and a first one of the single photon detectors to the first photonic link segment; and couple a second one of the single photon detectors to the second photonic link segment.

In some embodiments the plurality of matter qubits is configured to provide a part of a 3D quantum graph state that has a connected three-dimensional graph structure, wherein: the 3D quantum graph state comprises a number of 2D slices in an order from a first one of the 2D slices to a last one of the 2D slices, each of the 2D slices comprising a plurality of vertices and a plurality of intra-slice edges that connect vertices within the 2D slice in a 2D graph structure; the 3D quantum graph state includes inter-slice edges that interconnect different ones of the 2D slices such that each of the 2D slices is connected by one or more of the inter-slice edges to one or more other ones of the 2D slices; and the part of the 3D quantum graph state comprises a plurality of sequential ones of the 2D slices.

In some embodiments the part of the 3D quantum graph state that the plurality of matter qubits is configured to provide is made up of two sequential ones of the 2D slices.

In some embodiments the matter qubits comprise a plurality of distinct subsets and each of the plurality of 2D slices in the part of the 3D quantum graph state provided by the plurality of matter qubits is provided by a corresponding one of the distinct subsets of the plurality of matter qubits.

In some embodiments the matter qubits of each of the distinct subsets of the matter qubits are arranged in a regular array on the substrate and the regular arrays corresponding to different ones of the distinct subsets are offset relative to one another in a direction parallel to a plane of the substrate.

In some embodiments each of the regular arrays of the matter qubits has a regular structure of unit cells and matter qubits of one of the regular arrays lie inside the unit cells of another one of the regular arrays.

In some embodiments the 3D quantum graph state is a 3D quantum cluster state.

In some embodiments the network of photonic links comprises one of the single photon sources and two of the photon detectors associated with each one of the matter qubits.

In some embodiments the matter qubits are arranged in a first plane and one or more of the single photon sources or one or more of the single photon detectors are arranged in a second plane that is spaced apart from the first plane.

In some embodiments each of the matter qubits is coupled to an optical cavity having a resonant frequency corresponding to an energy separating one of the first and second basis states of the matter qubit from an excited state of the matter qubit.

In some embodiments the optical cavity is coupled between two of the photonic links of the network of photonic inks.

In some embodiments the optical cavities are evanescently coupled to one or both of the two photonic links of the network of photonic inks.

In some embodiments the photonic links are provided by a dual-rail photonic network comprising active optical switches that interconnects all of the matter qubits.

In some embodiments the single photon sources comprises heralded single photon sources.

In some embodiments the single photon sources comprises on demand single photon sources.

In some embodiments the optical switches comprise Mach-Zehnder Interferometer (MZI) switches.

In some embodiments the MZI switches comprise mechanical phase modulators.

In some embodiments the substrate is a silicon substrate.

In some embodiments at least a part of the substrate in which the matter qubits are located is enriched in one or more nuclear spin free stable isotopes of silicon.

In some embodiments at least a part of the substrate in which the matter qubits are located comprises or consists essentially of isotopically purified silicon-28, isotopically purified silicon-30 or a mixture thereof.

In some embodiments the substrate is a silicon on insulator substrate.

In some embodiments the apparatus comprises a refrigerator coupled to cool the substrate to a temperature of 4K or lower.

In some embodiments the apparatus comprises a microwave control system configured to direct microwave radiation onto the substrates to control quantum states of individual ones of the matter qubits.

In some embodiments the matter qubits comprise donor qubits.

In some embodiments the donor qubits comprise impurity atoms implanted in the substrate.

In some embodiments the impurity atoms comprise ionized Se atoms.

In some embodiments the Se atoms are singly ionized and the matter qubits each comprise quantum information encoded in the ground state manifold of one of the singly ionized Se atoms.

In some embodiments the apparatus comprises a control system operative to control the photonic network to perform deterministic entangling parity measurements on a selected one of the pairs of matter qubits by: configuring the optical switches in the network of photonic links so that each of the matter qubits in the selected pair is coupled between corresponding first and second photonic link segments; controlling a corresponding one of the single photon sources to inject a photon into the first photonic link segment; and detecting a signal indicating the detection of the photon from the first one of the single photon detectors or the second one of the single photon detectors.

In some embodiments the control system is further configured to automatically configure quantum states of a set of the matter qubits to provide one of the 2D slices by: entangling quantum states of the set of matter qubits to create a plurality of distinct tree-like graph states, fusing the tree like graph states together and fusing the tree like graph states to a 2D graph state of a previous one of the 2D slices.

Another aspect of the invention provides an apparatus for quantum computing. The apparatus comprises a substrate comprising a plurality of matter qubits each having a plurality of computational basis states; a dual rail photonic network coupled to the matter qubits, the photonic network comprising: first and second optical waveguides each coupled to each of the plurality of matter qubits; a plurality of single photon sources; a plurality of single photon detectors; a plurality of optical switches in the first and second optical waveguides, the optical switches operable to configure the photonic network to perform a deterministic entangling parity measurement on any pair of a plurality of pairs of the matter qubits by: optically isolating sections of the first and second waveguides that are coupled to the matter qubits of the pair; connect one of the single photon sources to inject single photons into the section of the first optical waveguide; connect a first one of the single photon detectors to detect photons in the section of the first optical waveguide; and connect a second one of the single photon detectors to detect photons in the section of the second optical waveguide.

In some embodiments each of the matter qubits is coupled to a corresponding optical cavity that is coupled between the first and second optical waveguides.

In some embodiments the optical cavity has a resonant frequency corresponding to a characteristic energy associated with a dipole-allowed transition from one of the first and second computational basis states of the matter qubit to a higher-energy excited state of the matter and the single photon has a frequency substantially equal to the resonant frequency.

In some embodiments the apparatus comprises a control system operative to control the photonic network to perform deterministic entangling parity measurements on a selected one of the pairs of matter qubits by: configuring the photonic network to perform a deterministic entangling parity measurement on the selected pair of the matter qubits; controlling the corresponding one of the single photon sources to inject a photon into the section of the first optical waveguide; and detecting a signal indicating the detection of the photon from the first single photon detector or the second single photon detector.

In some embodiments the control system is configured to build a 2D quantum graph state by a knitting procedure which includes performing the deterministic entangling parity measurements on a sequence of pairs of the matter qubits.

In some embodiments the knitting procedure comprises: initializing a quantum state of one of the matter qubits corresponding to an initial vertex of the quantum graph state; and sequentially adding vertices to complete a 2D tree-like graph structure of the 2D quantum graph state by, for each of the added vertices: preparing a corresponding one of the matter qubits that is not already included in the 2D quantum graph state in the state |+ [symbol] , where |+ [symbol] is the eigenstate of the Pauli operator X with the eigenvalue+1; measuring the correlated observable Zₙ⊗Zₙ₊₁ where Zₙ operates on one of the matter qubits corresponding to a vertex of the 2D tree-like graph structure under construction and Zₙ₊₁ operates on the matter qubit corresponding to the vertex being added and ⊗ is the tensor product; conditionally, if the measurement of the observable Zₙ⊗Zₙ₊₁ yields a value of −1, applying the Pauli operator Xₙ₊₁ to the matter qubit corresponding to the vertex being added; and applying a Hadamard gate Hₙ₊₁ to the matter qubit corresponding to the vertex being added.

In some embodiments the substrate is a silicon substrate.

In some embodiments at least a prat of the substrate in which the matter qubits are located is enriched in one or more nuclear spin free stable isotopes of silicon.

In some embodiments the substrate comprises or consists essentially of isotopically purified silicon-28, isotopically purified silicon-30 or a mixture thereof.

In some embodiments the substrate is a silicon on insulator substrate.

In some embodiments the matter qubits comprise donor qubits.

In some embodiments the donor qubits comprise impurity atoms implanted in the substrate.

In some embodiments the impurity atoms comprise ionized Se atoms.

In some embodiments the Se atoms are singly ionized and the matter qubits each comprise quantum information encoded in the ground state manifold of one of the singly ionized Se atoms.

Another aspect of the invention provides a control system for a quantum computing apparatus comprising a data processor and stored instructions executable by the data processor which, when executed cause the data processor to perform a method as described herein and/or a computer program product comprising a tangible data storage medium carrying machine readable instructions executable by a data processor which, when executed by the data processor, cause the data processor to perform a method as described herein.

Other aspects of the invention provides apparatus having any new and inventive feature, combination of features, or sub-combination of features as described herein.

Other aspects of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 schematically illustrates a quantum computing apparatus according to an example embodiment.

FIGS. 2A, 2B, 2C show examples of graph states that may be pre-fabricated and then combined to yield cluster states of arbitrarily large sizes.

FIG. 3 illustrates closing a loop on a previously line-like graph state using fusion.

FIG. 4 illustrates creating a cluster state in one spatial dimension.

FIG. 5 illustrates creating the same 1D cluster state as a plurality of zero dimensional slices at different times.

FIGS. 6A and 6B illustrate the concept of slicing a cluster state into slices which have dimensionality one less than the cluster state.

FIGS. 7A to 7F illustrate a way in which vertices of a 1D cluster state may each be assigned to one of two parties or layers and how such a cluster state may be realized by a series of slices that are not all present at the same time.

FIG. 8 shows an elementary cell of an example 3D cluster state which has a face centered cubic geometry.

FIG. 9 schematically illustrates the process for creating a 3D cluster state and using it for one way computing.

FIGS. 10A to 10G illustrate construction of a 3D graph state made up of FCC unit cells as shown in FIG. 8.

FIGS. 11A and 11B illustrate example apparatuses that may be applied for making correlated entangling measurements of two qubits. FIG. 11C shows a single qubit measurement and FIG. 11D shows a non-local measurement on two qubits.

FIG. 12 is an example 2D grid of arrayed qubit units. FIG. 12A is an example 2D graph state that constitutes a corresponding layer. FIGS. 12B and 12C are examples 2D graph states where the corresponding layers are fused together.

FIG. 13 shows an example physical layout for a part of a photonic circuit.

FIG. 14A is a cross section of a typical glass-cladded SOI waveguide. FIG. 14B is a top view of a waveguide crosser.

FIG. 15A shows a typical design for an MZI switch. FIG. 15B shows an example type of a phase modulator.

FIG. 16 shows an example phase modulator based on mechanical movement.

FIGS. 17A and 17B show two examples of heralded photon sources.

FIGS. 18A and 18B show example simple photon detectors. FIG. 18C shows the portion of FIG. 18B enclosed by the dashed lines.

FIG. 19 illustrates a part of an optical circuit that uses components as described above to implement a quantum computing apparatus of a type described herein.

### DEFINITIONS

The following definitions taken together with the rest of this disclosure explain meanings of certain terms of art that are used in this disclosure. Other terms are defined and used in the detailed description.

“Entanglement” is a way of describing the non-local character of quantum states. A quantum state is a “catalogue” of all properties that can be known of a given quantum system in a given configuration. Knowledge of the quantum state of a quantum system can be used to predict measurement statistics for every quantum-mechanically allowed measurement on the system (by the Born rule). The quantum state of a quantum system evolves in time according to the Schroedinger equation. A quantum system may be composed of two or more subsystems (which may be spatially separated). Quantum states of such subsystems are said to be “entangled” when the quantum states are quantum-mechanically correlated. For simplicity, consider two subsystems, denoted A and B. Entanglement of the quantum states of two subsystems A and B may be defined mathematically as follows. We begin with the more straightforward case of pure states (quantum states whose density matrix has a single eigenvalue of 1 and all other eigenvalues are 0). Pure states are conveniently described by state vectors |ψ [symbol] (using Dirac bra-ket notation).

Definition 1 (Entanglement for pure states) A joint quantum state |ψ [symbol] _{AB} on systems A and B is entangled if and only if it holds that

|ψ [symbol] _{AB}≠|ϕ [symbol] ⊗|ξ [symbol] _{B},∀|ϕ|ξ [symbol] .

Every valid quantum state that is not pure in a particular basis is mixed (i.e. is some linear combination of pure states). Mixed states are most conveniently described by density matrices p.
Definition 2 (Entanglement for mixed states) A joint quantum state ρ_{AB} on systems A and B is entangled if any only if it holds that

$${ρ}_{A B} \neq {\sum }_{i} {p}_{i} {σ}_{A} ( i ) ⊗ {τ}_{B} ( i ) , ∀ p , σ ( i ) , τ ( i ) .$$

Therein, p: i→pᵢ is a probability function, and the σ(i) and τ(i) are density matrices on A and B, respectively, dependent on the index i.

“Quantum coherence” is a property that allows a quantum system to remain in a quantum state made up of a particular superposition of basis states. For example, consider a one-qubit system that is prepared in a quantum state that is a superposition of the computational basis states |0 [symbol] and |1 [symbol] given by:

$$\vert ψ 〉 = \frac{\vert 0 〉 + {e}^{i ϕ} \vert 1 〉}{\sqrt{2}} .$$

If this one qubit system possesses quantum coherence and the system is completely isolated then the state will evolve according to the unitary time evolution operator and the quantum information of the above state will be preserved. The state |ψ [symbol] can be expressed as the following density matrix with respect to the basis states |0 [symbol] and |1 [symbol] as follows:

$$\vert ψ 〉 〈 ψ \vert = ∶ {ρ}_{ψ} ≅ \frac{1}{2} ( \begin{matrix}1 & {e}^{- i ϕ} \\ {e}^{i ϕ} & 1\end{matrix} ) .$$

The off-diagonal terms in the density matrix represent non-classical, quantum behavior. Quantum coherence is a property that preserves these off-diagonal components. Quantum coherence is a desirable property for qubits used in quantum computing because quantum information in quantum computing is often represented by coherent superpositions of basis states and increased quantum coherence causes such coherent superpositions to be longer lasting.

“Decoherence” is the opposite of coherence. Decoherence is the result of processes that, over time, convert coherent superpositions of quantum states into probabilistic mixtures of quantum states. Decoherence causes off-diagonal terms in density matrices to trend toward zero over time and diminishes quantumness. There are other effects of decoherence besides blurring or deleting relative phase information. Namely, decoherence processes may also affect occupation probabilities, e.g., through spin flips. For example, decoherence reduces or eliminates quantum entanglement. A main mechanism for decoherence is the uncontrolled interaction of a system of interest with its environment.

“Unitaries” or “unitary operators” are linear operators. An operator U(t) is unitary if:

U(t)^{†}U(t)=U(t)U(t)^{†}=I.

Where I is the identity operator and f indicates complex conjugation. Time evolution according to the Schroedinger equation is an example of a unitary operation. The physical implication of unitarity is the preservation of total probability. For example, one may decide to measure a qubit in the computational basis {|0 [symbol] ,|1 [symbol] } at any given time t₀. The probabilities p(0) of obtaining |0 [symbol] and p(1) of obtaining |1 [symbol] may vary with time t₀ as a result of time evolution according to U(t) but it is physically meaningful to require:

p(0)+p(1)=1,℄t₀.

This means that one can be certain that upon measurement, the system will be found in some state. However, to enforce this condition for different times t₀ puts a constraint on the evolution U(t) which is satisfied if U(t) is unitary.

“Universal” (for quantum computation) refers to a set of gates or primitives that are used in a scheme of quantum computing. A set of quantum gates is “universal” if by concatenating gates from the set into arbitrarily long sequences, any unitary evolution can be arbitrarily closely approximated, in any finite Hilbert space dimension. Quantum gate sets that are not universal are still useful in some contexts. For example, schemes for quantum computation with so called “magic states” may use gate sets that are not universal. However, when the gates are applied to suitable one-qubit states (the magic states), computational universality is restored.

“Hadamard gate” “H” is a one-qubit unitary gate that is part of many universal gate sets. Since H is one-qubit local, H can be visualized by its action on the Bloch sphere. There, it corresponds to a 180 degree rotation about an axis in the x-z plane that is right in the middle between the x- and z-axes.

In the above basis for one-qubit systems:

$$H ≅ \frac{1}{\sqrt{2}} ( \begin{matrix}1 & 1 \\ 1 & - 1\end{matrix} ) .$$

“Stabilizer states” are quantum states that correspond to groups of operators called “stabilizers”. It is convenient to work with stabilizer states because the stabilizers provide a compact way to reference the corresponding stabilizer state. It takes 2ⁿ complex amplitudes to represent a general pure quantum state of n qubits. For large n this number is very large. By contrast, stabilizer states on n qubits are defined by certain linear constraints. For an n-qubit stabilizer state, only n such constraints are required. This makes it relatively very compact to define stabilizer states in terms of their stabilizer relations. In addition, the classical simulation of the evolution of stabilizer states under certain unitary gates, namely the Clifford gates, is computationally efficient. The classical simulation of Pauli measurements on stabilizer states is also computationally efficient. Therefore, universal quantum computation requires additional operations beyond the above, for example, the one-qubit unitary gate

$${e}^{i ( \frac{π}{8} ) Z}$$

or the measurement of one-qubit observables (X+Y), (X−Y).

Quantum error correction, as practiced today, is based on the stabilizer formalism.

For the present disclosure it is sufficient to consider application of the stabilizer formalism on multi-qubit systems which exist in Hilbert space of dimension=2. To begin, we define the Pauli observables on a single qubit. We have, in the computational basis, {|0 [symbol] , |1 [symbol] }:

$${σ}_{x} ≅ ( \begin{matrix}0 & 1 \\ 1 & 0\end{matrix} ) , {σ}_{y} ≅ ( \begin{matrix}0 & - i \\ i & 0\end{matrix} ) , {σ}_{z} ≅ ( \begin{matrix}1 & 0 \\ 0 & - 1\end{matrix} ) .$$

Physically, these matrices represent the components of spin on a spin-1/2 system. The identity operator:

$$I ≅ ( \begin{matrix}1 & 0 \\ 0 & 1\end{matrix} )$$

is also a Pauli operator.

If two or more qubits are present one can form tensor products of Pauli observables. Examples of those for the case of two qubits include:

σₓ⁽¹⁾⊗σ_{y}⁽²⁾,σ_{y}⁽¹⁾⊗σ_{z}⁽²⁾,

Here, the superscripts denote the qubit label. Because these Pauli operators act non-trivially on more than one qubit, they are sometimes called non-local Pauli operators. The justification for this terminology is that measurement of such non-local Pauli operators can create entanglement.

The n-qubit Pauli operators form a group that can be denoted as Pₙ under multiplication. Pauli operators either commute or anticommute. Stabilizer groups are Abelian subgroups of Pₙ (that is, all elements in stabilizer groups must pairwise commute), with the further constraint that the only element in the stabilizer group proportional to the identity is the identity itself.

To define stabilizer states, maximal stabilizer groups are used. For n-qubit systems, such groups have 2ⁿ elements and can be generated by n elements:

S= [symbol] g₁,g₂, . . . , gₙ [symbol] (1)

Definition: Let S be a maximal stabilizer group according to Eq. (1). Then, the corresponding stabilizer state |ψ [symbol] is the unique state (up to global phase) satisfying the constraints

gᵢ|ψ=|ψ [symbol] , 1≤i≤n.

The simplest examples of stabilizer states are the computational basis states which are fully defined, respectively, by the stabilizer relations

|0 [symbol] =σ₂|0 [symbol] ,|1 [symbol] =(−σ_{z})|1

[symbol]

That is, [symbol] = [symbol] σ_{z} [symbol] and [symbol] = [symbol] −σ_{z} [symbol] .

A Bell state is any of the four states:

$${\vert {B}_{00} 〉}_{A B} = \frac{{{{{\vert 0 〉}_{A} ⊗ \vert 0 〉}_{B} + \vert 1 〉}_{A} ⊗ \vert 1 〉}_{B}}{\sqrt{2}} .$$

$${\vert {B}_{01} 〉}_{A B} = \frac{{{{{\vert 0 〉}_{A} ⊗ \vert 0 〉}_{B} - \vert 1 〉}_{A} ⊗ \vert 1 〉}_{B}}{\sqrt{2}} ,$$

$${\vert {B}_{10} 〉}_{A B} = \frac{{{{{\vert 0 〉}_{A} ⊗ \vert 1 〉}_{B} + \vert 1 〉}_{A} ⊗ \vert 0 〉}_{B}}{\sqrt{2}} ,$$

$${\vert {B}_{11} 〉}_{A B} = \frac{{{{{\vert 0 〉}_{A} ⊗ \vert 1 〉}_{B} - \vert 1 〉}_{A} ⊗ \vert 0 〉}_{B}}{\sqrt{2}} .$$

Bell states are another example of stabilizer states. For example, |B₀₀ [symbol] has the stabilizer:

[symbol]

S_{B}_{₀₀}= [symbol] σₓ^{(A)}⊗σₓ^{(B)},σₓ^{(A)}⊗σ_{z}^{(B)} [symbol] .

The four Bell states are Pauli equivalent (one can travel from one to another by applying Pauli operators).

Graph states are a large class of stabilizer states. Up to local unitary equivalence, every stabilizer state is a graph state. If G(V; E) is a graph with a vertex set V, |V|=n (where |.|returns the number of elements in a set), and an edge set E. Then, the corresponding graph state G) is a stabilizer state with stabilizer

$${S}_{\vert G 〉} = 〈 {σ}_{x}^{( a )} {\prod }_{b ∈ V \vert ( a , b ) ∈ E} {σ}_{z}^{( b )} , ∀ a ∈ V 〉 .$$

The simplest non-trivial example of a graph state is the state corresponding to the complete graph K₂, which has two vertices, connected by an edge. The corresponding graph state K₂ [symbol] _{AB} has the stabilizer

[symbol]

= [symbol] σₓ^{(A)}⊗_{z}^{(B)},σ_{z}^{(A)}⊗σₓ^{(B)} [symbol] .

A “tree graph” is a graph that contains no loops. Graph states on tree graphs are a subset of graph states.

A “cluster state” is a graph state where the corresponding graph is that of a lattice in some dimension. Cluster states in 1D are the simplest example but the phenomenology of 1D cluster states is not as rich as it is for cluster states in higher dimensions. 2D cluster states may be used for universal quantum computing. 3D cluster states facilitate quantum computation with fault-tolerance with high threshold, on top of universality.

“Stabilizer codes” are like stabilizer states but they are defined by a stabilizer group which is not maximal. If the number of generators in the stabilizer group S is m and the number of physical qubits is n, then the number of logical qubits that can be encoded with the stabilizer code described by S is:

k=n−m.

Stabilizer codes may be applied to provide fault tolerance in quantum computing because certain changes to the states of the physical qubits of the stabilizer code do not change the logical qubits that are encoded by the stabilizer code.

“Surface codes” are an example of stabilizer codes. As with graph states, the stabilizer group for a surface code can be read-off from a geometrical object; this time a surface and its tessellation. Here, we consider orientable surfaces without boundary. Such surfaces include the torus and its multi-handle generalizations.

Surface codes are an example of topological quantum codes. One effect of the topology is that for a surface code on the torus, the number k of logical qubits is independent of which tessellation of the torus is chosen, k=2. If we allow more handles (# handles=genus g), then the number of logical qubits is k=2g, again independent of the tessellation.

For notational and graphical convenience, consider the ordinary torus, with a single handle and tessellations of the torus that consist of square tiles. A tessellation of a torus can be considered to be a graph consisting of vertices v∈V and edges e∈E. This graph is embeddable in the torus, hence it also defines faces f∈F. With the above tessellation of a torus, every face (=tile) f is bounded by four edges, e and every edge e is between two vertices, v. Also, every vertex v is in the boundary of four edges.

The qubits in the surface code are associated with the edges; there is one qubit per edge. The stabilizer generators are associated with the vertices and the faces; there is one stabilizer generator for each vertex and one stabilizer generator for each face. The stabilizer generators for the surface code are:

$${B}_{f} = {}_{e ∈ \{ \partial f \}}^{⊗} {σ}_{z}^{( e )} , {A}_{v} = {}_{e \vert v ∈ \{ \partial f \}}^{⊗} {σ}_{x}^{( e )} .$$

where ∂ is the boundary operator. B_{F} are known as “plaquette stabilizers”. Aᵥ are known as “vertex stabilizers”.

“Local” in the context of “local architecture” means an architecture, e.g. for a quantum computer that can be laid out in three or fewer spatial dimensions. An example local architecture lays out qubits on a translation invariant lattice in 3 or lower dimension, and all required operations are short-range, i.e, only require the application of unitary gates and measurements on sets of “nearby” qubits. Quantum computer architectures that are local in 2D have particular commercial relevance as such architectures may for example, be realized by processing a substrate such as a semiconductor wafer, In some cases much or all of the processing may apply technologies and infrastructure that have been developed for semiconductor fabrication.

Limiting gates to short range gates can help to realize an envisioned architecture despite space limitations on a particular substrate.

“Deterministic entangling measurement” means a measurement which deterministically creates a desired type of entanglement on quantum states of two or more qubits. The measurement outcome of a deterministic entangling measurement may be probabilistic. A Bell measurement, i.e., a measurement in the Bell basis formed by the Bell states identified above is an example of a deterministic entangling measurement. Which Bell state is the result of any particular measurement is probabilistic. However, immediately after a Bell measurement, the qubits on which the Bell measurement was performed will always have the same kind of entanglement. Another example of a deterministic entangling measurement is a two qubit ZZ parity measurement as described herein.

A “donor spin qubit” is a qubit which is physically realized by the spin state of an unpaired electron loosely bound to an impurity atom in a semiconductor crystal. An example of a donor spin qubit is a qubit that uses the spin state of a singly ionized selenium atom in silicon to represent quantum information.

A “matter qubit” is a quantum system made up of matter particles (e.g. electrons, atoms, nuclei) that has quantum states that can be used as computational basis states. A photon is not a matter qubit. A donor spin qubit is a non-limiting example of a matter qubit.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the invention provides an architecture for fault-tolerant universal quantum computation that comprises matter qubits coupled by photonic interconnects. The matter qubits may be supported by a silicon substrate. In some embodiments all or part of the substrate is enriched in one or more nuclear spin free stable isotopes of silicon. For example, the entire substrate or a layer of the substrate in which the matter qubits are located may be enriched in nuclear spin free stable isotopes of silicon (e.g. isotopically purified silicon-28, isotopically purified silicon-30 or a mixture thereof).

The matter qubits may comprise, for example, donor qubits in silicon. The donor qubits may comprise, for example, ionized impurity atoms. The impurity atoms may comprise, for example, selenium (Se) atoms.

Each qubit may, for example, be encoded in two states that are part of the ground state manifold of a corresponding donor qubit. These states may be called “computational basis states”. For example, where the donor qubits are ionized Se atoms (Se⁺) the qubit basis states may be the ground state and a first excited state of the ionized Se atoms (e.g. states which correspond to spin down and spin up states of the Se+ unpaired electron). These basis states may be measured and manipulated via a 2.9 μm resonant dipole transition.

The photonic interconnects may comprise a network of optical waveguides supported in or on a silicon substrate. The network can include additional components such as optical resonators, optical switches, single photon sources, and photon detectors as described herein. The waveguides and additional components may be arranged in a single layer or in plural layers. For example, in some embodiments the waveguides are arranged in a first plane and single photon sources and single photon detectors are arranged out of the first plane (e.g. in a second plane spaced apart from the first plane). In some embodiments the first plane is closer to the matter qubits than the second plane.

Such apparatus may be constructed using known techniques for making highly-integrated classical photonic circuitry in silicon-on-insulator wafers.

In operation the apparatus is cooled to low temperatures. For example, in some embodiments the apparatus is operated at temperatures of 4K or lower. In some embodiments, the apparatus is operated at temperatures in the range of 1K to 4K.

As described below, such apparatus may be controlled to perform elementary logical operations including one-qubit unitaries and 2-local correlated Pauli measurements. As described below, these logical operations may be applied to create and apply three-dimensional resource states which combine topological quantum error-correction capabilities with the resilience to heralded gate error characteristic of photonic entangling gates.

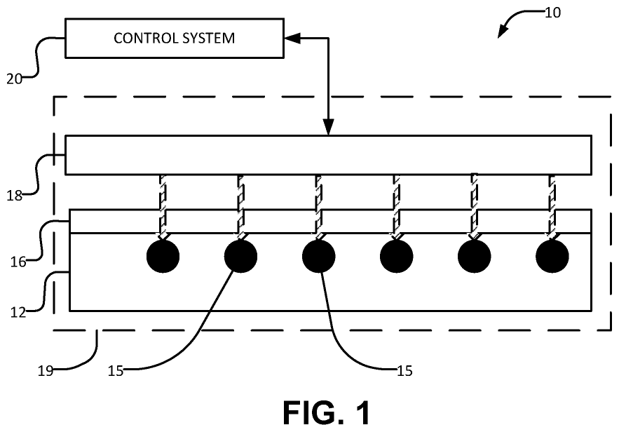

FIG. 1 schematically illustrates a quantum computing apparatus 10 according to an example embodiment. Apparatus 10 includes a silicon substrate 12. Embedded in substrate 12 are a plurality of donors which serve as matter qubits 15. Apparatus 10 may include a large number of spaced apart qubits 15 on one or more substrates 12. Qubits 15 may, for example, comprise Se ions.

Apparatus 10 also comprises an optical network 16 supported by substrate 12. Optical network 16 comprises optical waveguides, optical resonators (e.g. optical cavities), optical switches, single photon sources and/or photon detectors. Example constructions of optical network 16 are described below.

Apparatus 10 includes:
control and measurement apparatus 18 operative to initialize qubits 15 to desired quantum states, manipulate the quantum states of qubits 15 and/or measure observables of individual qubits 15;
a refrigerator 19 operative to cool substrate 12 to a desired operating temperature; and
a control system 20, which may, for example, comprise a digital computer configured by software to operate control and measurement apparatus 18 to perform quantum computation as described herein.

Control and measurement apparatus 18 may, for example comprise known technologies for controlling quantum states of matter qubits such as:
magnets controllable to provide selected magnetic fields at the locations of the qubits;
microwave and/or RF pulse generators and antennas for delivering pulses of electromagnetic radiation to qubits;
electrical potential sources and electrodes controllable to applying electric fields to matter qubits; and
other known technologies for implementing quantum gates and/or otherwise controlling and/or measuring quantum states of matter qubits.

### Cluster States and Graph States

Qubits 15 may be prepared to provide a resource state for quantum computing. The resource state may be a graph state such as a cluster state. Graph states are special stabilizer states in which the corresponding stabilizer can be described by a graph.

A stabilizer is a set of transformations. A stabilizer state is a quantum state for which application of any of the transformations of the corresponding stabilizer does not change the state (i.e. the stabilizer has eigenvalue+1 for every transformation that belongs to the corresponding stabilizer). A stabilizer state may be a state of n qubits. Every stabilizer state is local Clifford equivalent to a graph state.

A graph state |G [symbol] is defined with reference to a graph G which includes a number of vertices V(G) where pairs of the vertices are joined by edges E(G). Each vertex V(G) corresponds to a qubit. The graph state |G [symbol] is a stabilizer state on |V(G)| qubits, with one qubit for every vertex of G.

|G [symbol] satisfies the stabilizer relations:

Kₐ|G [symbol] =|G [symbol] ,

where the stabilizer generators are given by

$${{K}_{a} := {X}_{a} ⊗ {Z}_{b}}_{a ∈ V ( G ) \vert ( a , b ) ∈ E ( G )}$$

where a and b are indices that identify vertices V(G) and pairs (a, b) identify edges E(G) by the vertices that they extend between, and Xₐ⊗Z_{b} represent correlated observables for all a∈V(G)|(a, b)∈E E(G). These stabilizer relations define the graph state uniquely, up to an unphysical global phase.

Cluster states are special graph states in which the interaction graph G is that of a regular lattice in d spatial dimensions. Cluster states in spatial dimension 2 are universal for quantum computation by local measurement. 3D cluster states may be used for universal and fault-tolerant quantum computation by local measurement.

An alternative way to characterize graph states (including cluster states) is through a particular method of their creation. Namely, up to Pauli equivalence, cluster and graph states can be created through unitary evolution from a product state under the Ising Hamiltonian which is:

$${H}_{Ising} = J {\sum }_{i , j ∈ E ( V )} {Z}_{i} {Z}_{j}$$

where J is a coupling strength between pairs of qubits i and j which share an edge, and Zᵢ and Zⱼ represent one-qubit measurements. Namely, |G [symbol] =e^{iπ/4H}^{_{ISing}}⊗_{i∈V(G)}|+ [symbol] ᵢ where |+ [symbol] is the eigenstate of X with eigenvalue+1.

Methods for quantum computing according to some aspects of the present invention include steps of:
Creating a 3D cluster state as a time sequence of 2D slices; and
Performing quantum computations by performing measurements on the qubits in each of the slices after the slice has been created.
   The slices of the 3D cluster state may be created in matter qubits that are interconnected by a photonic network as described herein. Advantageously the 3D cluster state may have any size in the time dimension. Qubits that have been used for one slice may be reused over and over again for other slices after the measurements have been performed.

### Quantum Computational Primitives

The above methods may be implemented by performing operations selected from the following set of operational primitives which act on a set Ω of qubits:
All one-qubit unitaries Uᵢ, for all qubits i∈Ω,
one-qubit Zᵢ-measurements, for all qubits i∈Ω
Measurement of the correlated observable Zᵢ⊗Zⱼ, for all i, j∈Ω.

These computational primitives may be applied to create 3D cluster states, and to fault-tolerantly compute on the 3D cluster states by local measurement.

### Creation of Graph States

A graph state which includes loops, such as a cluster state, may be created by creating graph states that have tree like graphs and then connecting these graph states together. Tree like graph states may be created for example using a process which in this disclosure is called “knitting”. Edges that join two of the tree-like graphs together may be created, for example, by a process which in this disclosure is called “fusion”.

Knitting is more efficient than fusion, but is limited to creating graph states on tree-like graphs. Fusion may be used to add vertices which create loops or cycles in the graph state being created.

### Deterministic Creation of Tree-Like Graph States—Knitting

Knitting may be applied to create arbitrarily large tree-like graph states including arbitrary long 1D graph states. Knitting involves performing a deterministic entangling measurement to add an additional qubit to a tree-like graph state. For example, knitting may involve measuring the correlated observable Z₁⊗Zⱼ where Z represents the Pauli z measurement and i and j are indices that indicate qubits on which the correlated measurement is performed. This measurement is an example of a deterministic entangling parity measurement.

Knitting may start, for example with a 1D cluster state |Ψ(n) [symbol] of length n, n=1,2,3, . . . , with stabilizers K₁=X₁⊗Z₂,Kₙ=Z₋₁⊗Xₙ,

K₁=Zₗ₋₁⊗Xᵢ⊗Zᵢ₊₁, l=2, . . . , n−1. (2)

For example, knitting may start with the 1D graph state that consists of a single qubit that has been prepared in the state |+ [symbol] where

$$\vert + 〉 = \frac{\vert 0 〉 + \vert 1 〉}{\sqrt{2}} .$$

Knitting may for example add a qubit to an existing graph state that includes n qubits to yield a graph state that includes n+1 qubits by the steps of:
1. Preparing a qubit n+1 in a suitable initial state (e.g. the state |+ [symbol] ), resulting in the state |Ψ(n) [symbol] ⊗+ [symbol] ₙ₊₁.
2. Performing a deterministic entangling measurement on the last two qubits, for example, measuring the observable Zₙ⊗Zₙ₊₁ on the last two qubits where Zₙ is the Pauli operator Z. This measurement may be described as a ZZ parity measurement since the possible outcomes depend on whether the last two qubits have the same or different states.
3. If the outcome of the measurement in step 2 is “−1” then applying an operator that flips the state of one of the qubits (e.g. in this example applying the Pauli operator Xₙ₊₁ to the last qubit).
4. Applying a Hadamard gate Hₙ₊₁ to the last qubit.
   After this procedure the tree-like graph state has been expanded to include one more qubit.

Branches may be created by, in step 2, measuring the observable Zₘ⊗Zₙ₊₁ where Zₘ acts on a qubit m in the existing graph state that is already connected by edges to two or more other qubits in the existing graph state.

It can be seen that the stabilizer of the state present after step 1 is generated by Eq. (2) and the Pauli observable Xₙ₊₁. The state resulting after step 2 retains the stabilizers K₁, . . . , Kₙ₋₁, while Kₙ and Xₙ₊₁ anti-commute with the measurement and are thus removed from the stabilizer. However, their product \tilde{K}ₙ=Kₙ⊗Xₙ₊₁ is included in the stabilizer. The measurement (and conditional rotation of step 3) add the stabilizer \tilde{K}ₙ₊₁=Zₙ⊗Zₙ₋₁. Step 4 changes \tilde{K}ₙ→Zₙ₋₁ ⊗Xₙ ⊗Zₙ₊₁ and \tilde{K}ₙ₊₁=Zₙ⊗Xₙ₊₁. Thus the knitting process described above yields a state that has the stabilizer of an n+1 qubit graph state.

A shortcoming of the knitting process is that knitting cannot be used to create vertices that close loops (or “cycles”) in a graph state. Creating a loop requires another process.

In methods according to some embodiments a plurality of tree like graph states are created, for example by knitting as described above. These tree like graph states optionally all comprise the same number of qubits and/or all have congruent graphs (i.e. these “pre-fabricated” graph states may be the same except for the particular matter qubits that they are states of).

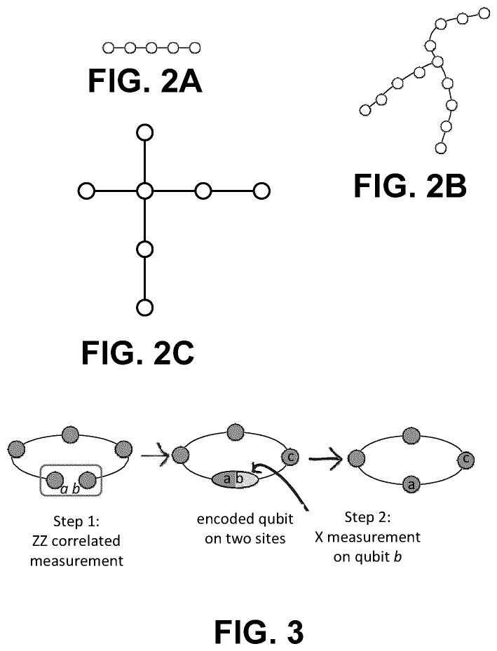

FIGS. 2A, 2B, and 2C show examples of graph states that may be pre-fabricated and then combined to yield cluster states of arbitrarily large sizes. FIG. 2A shows a 1D cluster state made up of five qubits (l=5). FIG. 2B shows another example graph state that has the form of a three-armed star. FIG. 2C shows another example graph state that has the form of a cross. In FIGS. 2A to 2C, the small circles represent matter qubits and the lines that connect the small circles represent vertices of the associated graph.

### Creating Graph States on General Graphs—Fusion

In general, for a resource state to be used for one way computing in a way that can provide a quantum speedup the resource state must include loops. Tree-like graph states (e.g. graph states that can be created by knitting as described above) do not include loops. Fusion may be used to create graph states which include loops.

FIG. 3 illustrates an example application of fusion to close a loop on a previously line-like graph state. The procedure assumes no prior link (edge) between two qubits a and b.

Consider a graph state |G [symbol] where the graph G has an adjacency matrix Γ. Each element of Γ corresponds to a pair of vertices which each correspond to a qubit (e.g. element Γᵢⱼ corresponds to the vertices i and j). The value of the element σᵢⱼ is one if an edge joins vertices i and j and is zero otherwise. The task is to create an edge between two vertices a, b∈V (G) which are not currently connected by an edge (Γ_{ab}=0).

Fusion involves:
1. [Merging] Measurement of a correlated observable (e.g. Zₐ⊗Z_{b}).
2. [Decoding] Measurement of a local observable (e.g. X_{b}).

The measurement of the local observable can be made on either of qubits a and b. The measurement of the local observable may be made in bases other than X. For example, the measurement may measure the observable:

cos(α)X+sin(α)Y

where α is any angle.

The Decoding step removes qubit b from the graph state and creates a new edge between qubit a and qubit c to which qubit b was connected by an edge before the fusion operation.

The result is the update of the adjacency matrix

Γ→Γ′=AΓA^{T}

where the matrix A has the elements

Aᵢⱼ=δᵢⱼ−δ_{ib}δ_{jb}+δᵢₐδ_{jb}.

where δᵢⱼ is the Kronecker delta function that has the value 1 if i≠j and zero otherwise and A^{T} is the transpose of matrix A.

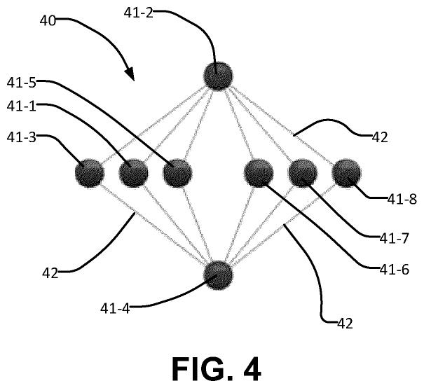

FIG. 4 shows an example polycyclic 2D graph state 40 comprising eight vertices 41 joined by 12 edges 42. Graph state 40 is one of the simplest graph states on which topological quantum error correction may be implemented. Each vertex of graph state 40 corresponds to a matter qubit. Quantum states of the matter qubits are entangled.

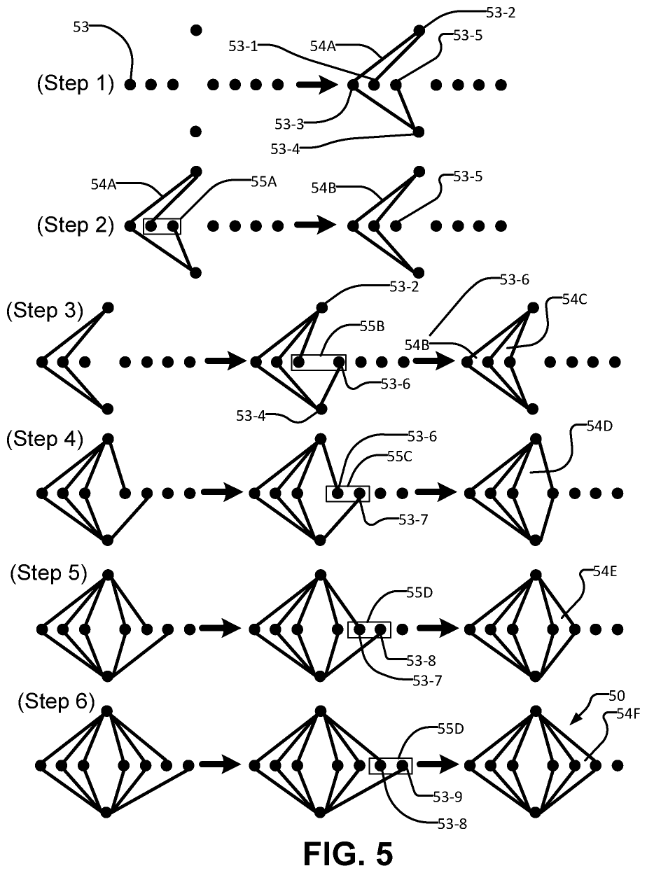

FIG. 5 shows an example sequence of configurations generated by knitting and fusion operations that may be applied to create graph state 50. Nine matter qubits 52 are used to create graph state 50. In step 1, a 1D graph state 54A is created by knitting together qubits 53-1 to 53-5. In step 2, fusion 55A is performed on qubits 53-1 and 53-5, thereby creating a new edge between qubits 53-1 and 53-2 and removing qubit 53-5 from the graph state. The result of fusion 55A is a closed loop 54B.

In step 3, knitting is applied to add one new edge that joins qubits 53-2 to 53-5 and another new edge that joins qubits 53-4 to 53-6. Fusion 55B is then performed on qubits 53-5 and 53-6, thereby creating a new edge between qubits 53-4 and 53-5 and removing qubit 53-6 from the graph state. The result of fusion 55B is a second closed loop 54C.

In step 4 another closed loop 54D is created by adding edges that respectively join qubit 53-2 to 53-6 and join qubit 53-4 to 54-7 and then performing fusion 55C. In step 5 another closed loop 54E is created by adding edges that respectively join qubit 53-2 to 53-7 and join qubit 53-4 to 54-7 and then performing fusion 55D. In step 6 another closed loop 54F is created to complete graph state 50 by adding edges that respectively join qubit 53-2 to 53-8 and join qubit 53-4 to 54-9 and then performing fusion 55E.

Fusion may be used to join together prefabricated tree-like graph states to yield arbitrarily large cluster states. For example, fusion may be used to create 3D cluster states based on lattices such as: cubic lattices, body-centered cubic lattices, face centered cubic lattices, honeycomb lattices, etc. The resulting 3D cluster states may be applied as resource states for fault tolerant one way quantum computing.

Topological fault-tolerance in graph states can be achieved whenever the corresponding graph can be associated with a 3D chain complex in the following manner. The 3D chain complex consists of 3, 2, 1, and 0-chains that represent volumes, faces, line segments and sites of the complex. There are boundary maps between these geometric objects in the usual intuitive manner. The vertices of the corresponding graph G are associated with the faces and with the line segments of the complex; namely, there is one vertex for each face and for each line segment. Line-segment vertices are connected to face vertices only, and vice versa, i.e. the graph G is bipartite. The edges of the graph are defined as follows: there is an edge e between a line-segment vertex I and a face vertex f if and only if the line segment/is in the boundary of the face f. Translation invariance of G, or any other simplifying feature on top of the chain complex structure, are not required.

In some embodiments the tree-like graph states are prefabricated by a control system 20 (see FIG. 2) that executes software instructions to operate a photonic network 16 in coordination with control and measurement apparatus 18 to perform knitting operations on different groups of matter qubits 15 to yield the tree-like graph states.

As discussed above, one dimension of a 3D cluster state may be the time dimension. Different 2D slices of the 3D cluster state may be operated on in sequence at different times. Using 3D cluster states in which one dimension is provided by time advantageously allows use of architectures that are local in two spatial dimensions rather than three. The same matter qubits may be reused for different 2D slices of the 3D cluster state. Only a part of the 3D cluster state made up of a plurality of the 2D slices needs to be realized at any particular time.

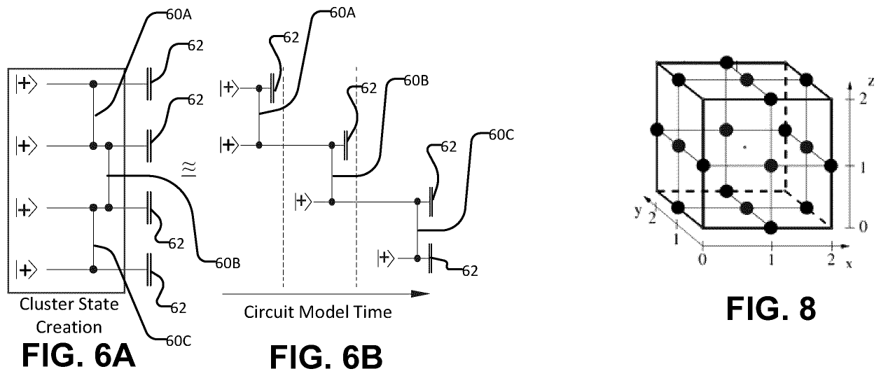

FIGS. 6A and 6B illustrate the concept of slicing a cluster state into slices which have dimensionality one less than the cluster state. For ease of illustration, FIGS. 6A and 6B treat the case of a 1D cluster state. In FIG. 6B, each slice is zero-dimensional, (i.e. each slice is provided by a single vertex).

FIG. 6A illustrates a set of commuting quantum gates 60A, 60B, 60C that operate simultaneously to entangle the states of four qubits (in this example, initially prepared in the state |+ [symbol] to yield a 1D cluster state. Gates 60A, 60B and 60C each act on two qubits. Gates 60A, 60B and 60C may, for example, be two-qubit unitary gates such as “controlled Z” gates. Single qubit measurements 62 may then be performed on the entangled states. In the implementation of FIG. 6A four qubits must be simultaneously present.

As shown in FIG. 6B, gates 60A, 60B and 60C can be re-ordered to operate sequentially at different times. This shows that the creation and subsequent measurement 62 of a cluster state can be understood as a sequence of elementary two-qubit operations. In this example, no more than two qubits of an arbitrarily long 1D cluster state need to be present at any given time.

FIGS. 7A to 7F illustrate a way in which vertices 71 of a 1D cluster state 72 may each be assigned to one of two parties or layers 73A, 73B. This assignment may be made where dimension 74 is time. A cluster state like cluster state 72 may be created and processed using two matter qubits 75A and 75B. As time progresses, qubits 75A and 75B correspond to different vertices 71 of cluster state 72. Each of matter qubits 75A, 75B corresponds to one of layers 73A, 73B.

In each time step, quantum states of the two matter qubits 75A, 75B are entangled and then a measurement is performed on one of the matter qubits 75A, 75B. The qubit 75A or 75B on which the measurement was performed is then re-initialized. The roles of the two matter qubits 75A and 75B alternate and quantum information is switched back and forth between the two matter qubits as cluster state 72 is processed.

FIG. 7A shows two matter qubits 75A and 75B that are initialized in an initial state such as |+ [symbol] . In FIGS. 7A to 7C, qubits 75A and 75B correspond to vertices 71-1 and 71-2 of cluster state 72. In FIG. 7B, qubits 75A and 75B have been entangled. In FIG. 7C a measurement has been performed on qubit 75A. After FIG. 7C, the quantum state of the remaining qubits depends on the measurement that has just been made on qubit 75A.

In FIG. 7D, qubit 75A is re-initialized. In FIGS. 7D through 7F, matter qubits 75A and 75B respectively correspond to vertices 71-3 and 71-2 of cluster state 72. In FIG. 7E, qubits 75A and 75B are entangled. In FIG. 7F, a measurement is performed on qubit 75B. This process may be continued until the desired computations are complete.

The principles illustrated in the one-dimensional examples of FIGS. 6A and 6B and 7A to 7F may be extended to the case of 3D cluster states or more generally 3D graph states on which fault tolerant universal quantum computing may be performed. In a 3D cluster state or graph state, each slice may comprise a 2D graph comprising plural vertices joined by plural edges.

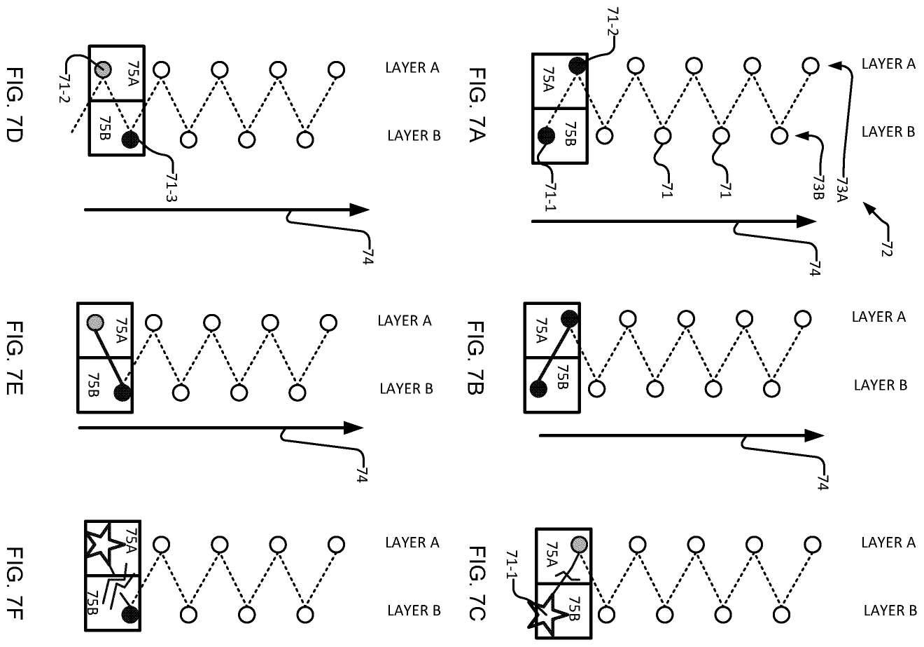

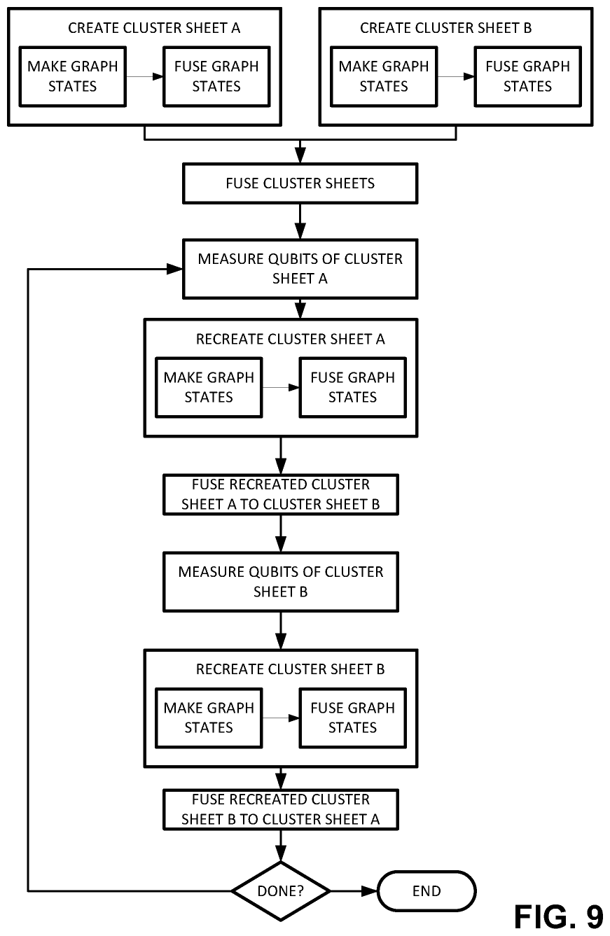

FIG. 8 shows an elementary cell of an example 3D cluster state which has a face centered cubic geometry. 3D cluster states of arbitrary size may be produced by tiling volumes of 3D space with this elementary lattice cell. Such 3D cluster states may be mapped to time series of two-dimensional slices in a manner similar to the procedure for 1 D cluster states illustrated in FIGS. 7A to 7F except that each slice corresponds to a 2D cluster state instead of a single vertex and so the 2D cluster states must be created. This may be achieved using only one-qubit unitary quantum operators and measurements plus two-qubit correlated Pauli-measurements.

A 3D cluster state may be generated and used for one way computing by a process as illustrated in FIG. 9 that comprises:
A. Creating two 2D cluster sheets. Each cluster sheet may be created by:
   a. Creating small graph states by knitting. The small graph states have forms that can be combined to yield the desired 2D cluster sheet. It is convenient but not mandatory for all of the small graph states to have the same form; and
   b. Combining the small graph states using fusion as described above.
B. Creating edges that join selected corresponding vertices of the two cluster sheets. This step can be visualized as positioning one of the 2D cluster sheets on top of the other one of the 2D cluster sheets and performing fusion to create edges that connect the two 2D cluster sheets together.

One way computation may then be started by performing quantum measurements on the qubits of the first cluster sheet. After the measurement the qubits of the first cluster sheet may be re-initialized and used to create another cluster sheet as described above. That cluster sheet may then be fused to the second cluster sheet after which quantum measurement may be performed on the qubits of the second cluster sheet. These processes may be repeated until the one way computation has been completed.

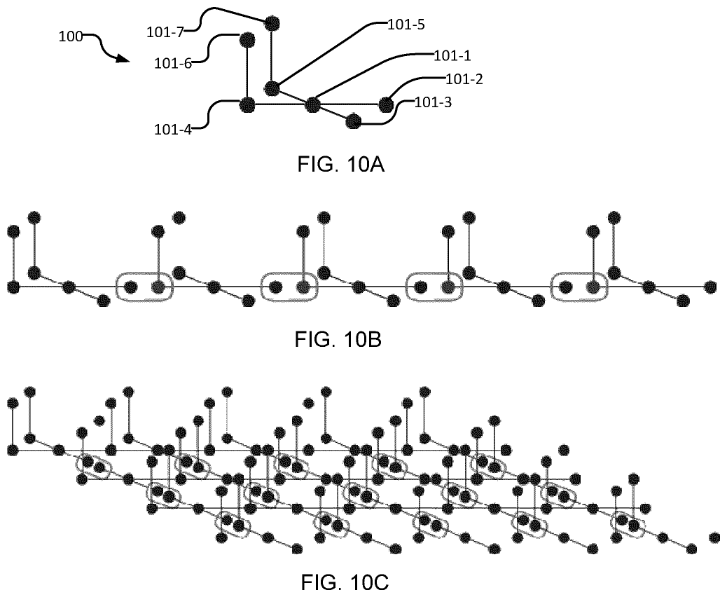

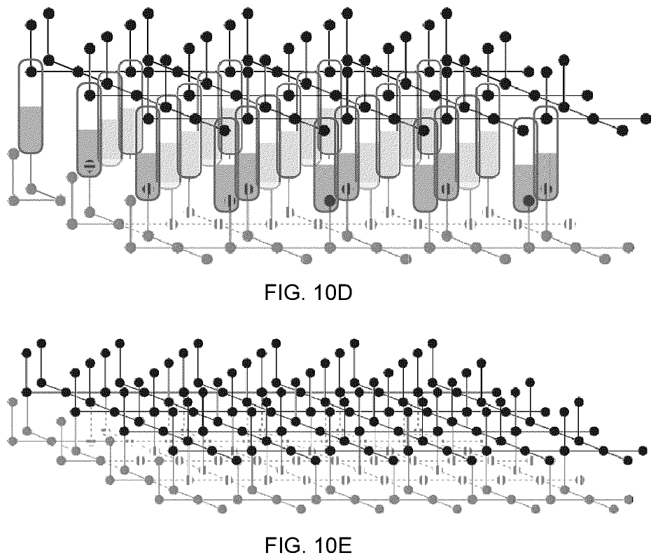

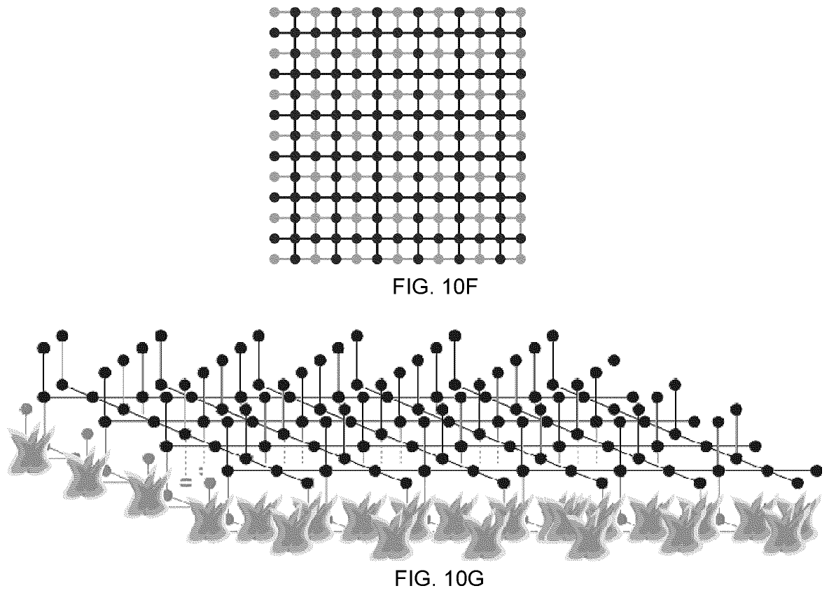

FIGS. 10A through 10G Illustrate construction of a 3D graph state made up of FCC unit cells as shown in FIG. 8. These figures illustrate an example case where tree like graph states having seven vertices as shown in FIG. 10A are assembled to form 2D cluster sheets.

The inventors have determined that one good form for pre-fabricated tree-like graph states is the 7-qubit unit 100 having the form shown in FIG. 10A. Unit 100 includes qubits 101-1 to 101-7. Qubits 101-4 and 101-5 may be used in fusing together different units 100 within the same layer. Qubits 101-6 and 101-7 are used in fusing together different layers.

FIGS. 10B and 10C illustrate stages in an example method of fusing units 100 together to create a sheet or layer. In FIGS. 10B and 10C, the rounded boxes indicate fusion and the shaded vertex in each rounded box is eliminated by the fusion operation from being included in the 2D cluster sheet. In this example case, intra-layer fusion is applied as shown in FIGS. 10B and 10C. Subsequently, different layers are fused through an inter-layer fusion procedure as illustrated in FIGS. 10D and 10E.

In FIG. 10D, a second cluster sheet (which may be created in the same manner) is positioned over a first cluster sheet (note the horizontal displacement by half a lattice cell). Fusion is performed to fuse the 2D cluster sheets together. Again. The rounded boxes indicate fusion and the shaded qubits are eliminated from the resulting cluster state by the fusion operation. FIG. 10E is another view showing the result of the fusion process. FIG. 10F is a top view showing the displacement between the layers (2D cluster sheets). FIG. 10G illustrates a step in executing a one-way quantum computing algorithm which involves making quantum measurements of the qubits which make up one of the 2D cluster sheets.

### Physical Implementations

A 3D cluster state as described above may be created and used for fault tolerant quantum computations using a 2D integrated photonics platform. The photonics platform may provide a number of qubits that are distributed in two dimensions (e.g. in a 2D array). These qubits may be selectively entangled to provide a 3D cluster state using the operations described herein.

One tool that is needed to implement the above methods is a practical two qubit deterministic entangling gate. Such a gate may, for example measure the correlated observable Zₐ⊗Z_{b} for two qubits a and b.

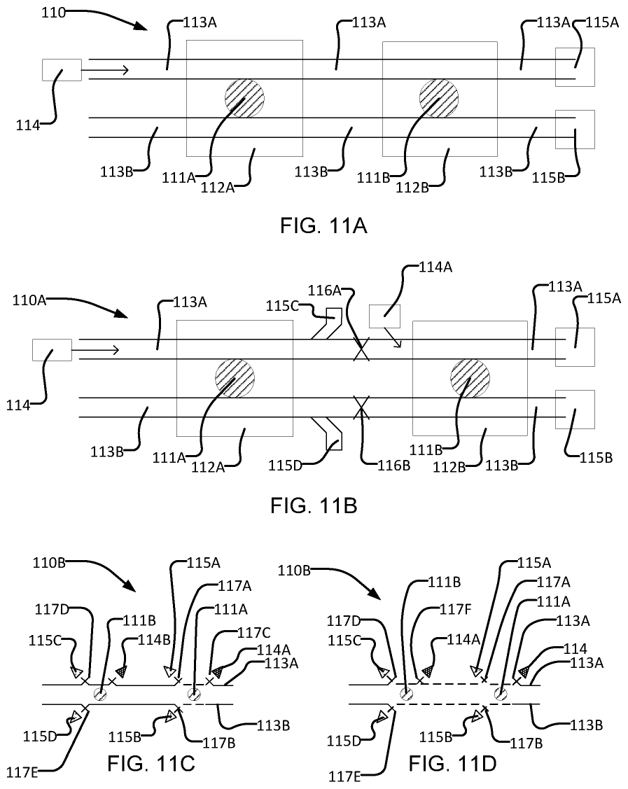

FIG. 11A illustrates apparatus 110 that may be applied for making correlated entangling measurements of two qubits 111A and 111B. Each of qubits 111A, 111B is coupled to a corresponding optical cavity 112A, 112B. A first excitation channel (waveguide) 113A is coupled to optical cavities 112A and 112B. A second excitation channel (waveguide) 113B is also coupled to optical cavities 112A and 112B. In some embodiments, excitation channels 113A and 113B are coupled (e.g. evanescently coupled) at opposing ends of each of optical cavities 112A and 112B. Optical cavities 112A and 112B are arranged as bridges between excitation channels 113A and 113B.

Qubits 111A and 111B each acts as a single quantum emitter and is each coupled to the resonant photonic cavity mode of the corresponding optical cavity 112A or 112B to change the empty cavity transmission (i.e. open or close the bridge), ideally from unity to zero, or vice versa, depending on the computational state of the corresponding one of qubits 111A, 111B.

Qubits 111A and 111B each has three non-degenerate states: a ground state |g [symbol] , a metastable state |m [symbol] separated from the ground state by a first energy ΔE1 and an excited state |e [symbol] , separated from the ground state by a second energy ΔE2>ΔE1. Excited state |e [symbol] is coupled to ground state |g [symbol] by a transition such as a dipole transition. Optical cavities 112 are resonant with the transition between |g [symbol] and |e [symbol] of the corresponding qubit 111. The states |g [symbol] and |m [symbol] can be used to encode the qubit information. In some embodiments ΔE1 GHz and ΔE2˜100 THz.

In an example embodiment, each qubit 111 consists of a single Se atom embedded in a 2D photonic crystal micro-cavity tuned to be in resonance with the g-e transition. Each such cavity 112 is symmetrically located between, and evanescently coupled to, two excitation channels (waveguides) 113, as shown in FIG. 11A.

Apparatus 110 includes a single photon source 114 coupled to deliver photons into excitation channel 113A and first and second photon detectors 115A and 115B respectively coupled to detect photons in excitation channels 113A and 113B.

Apparatus 110 may be applied to perform deterministic 2 qubit parity measurements on qubits 111A and 111B.

When a single photon is incident along excitation channel 113A a photon detection by detector 115A (Outcome 1) indicates Z₁Z₂=1, while a photon detection by detector 115B (Outcome 2) indicates Z₁Z₂=−1. This parity measurement can in principle be generalized to measure the observable Z^{⊗n} if the two cavities 112 shown in FIG. 11A are replaced by n linearly connected qubit-containing cavities.

Apparatus 110 of FIG. 11A may be modified to selectively allow single qubit measurements of the Pauli observable Z on either of qubits 111A and 111B or two qubit parity measurements on qubits 111A and 111B.

For example apparatus 110A shown in FIG. 11B is the same as apparatus 110 with the addition of optical switches 116A, and 116B, two additional photon detectors 115C and 115D and one additional single photon source 114A.

FIG. 11B illustrates one way in which active switches can be used to configure different quantum operations including local Z measurements of a single qubit and joint ZZ measurements as part of the knitting and fusion procedures. In FIG. 11B, a photon detection event of the upper detector signifies a measured eigenvalue of +1 and a photon detection event at the lower detector signifies a measured eigenvalue of −1.

A Z measurement of qubit 111A may be made by configuring switches 116A and 116B to direct light to photon detectors 115C and 115D, causing photon source 114 to emit a photon into excitation channel 113A, and detecting the photon at one of photon detectors 115C and 115D.

A Z measurement of qubit 111B may be made by configuring switches 116A and 116B as above, operating single photon source 114A to emit a photon into excitation channel 113A, and detecting the photon at one of photon detectors 115A and 115B.

A two qubit parity measurement on qubits 111A and 111B may be made by configuring switches 116A and 116B so that excitation channels 113A and 113B respectively optically couple both of qubits 111A and 111B to photon detectors 115A and 115B. With this configuration parity may be measured by emitting a photon from photon source 114 and detecting the photon at one of photon detectors 115A and 115B.

FIG. 11C shows an apparatus 110B which is configurable to make Z measurements of either of two qubits 111A and 111B or correlated ZZ measurements of the pair of qubits 111A and 111B.

For making a Z measurement of single qubit 111A:
switch 117A is controlled to connect single photon detector 115A to the part of excitation channel 113A to the right of switch 117A and to disconnect the part of excitation channel 113A to the right of switch 117A from the part of excitation channel 113A to the left of switch 117A;
switch 117B is controlled to connect single photon detector 115B to the part of excitation channel 113B to the right of switch 117B and to disconnect the part of excitation channel 113B to the right of switch 117B from the part of excitation channel 113B to the left of switch 117B;
switch 117C is controlled to connect single photon source 114A to direct photons into the part of excitation channel 113A to the left of switch 117C and to disconnect the part of excitation channel 113A to the left of switch 117C from the part of excitation channel 113A to the right of switch 117C.
   With this configuration the Z measurement of qubit 111A may be made by controlling photon source 114 to emit a photon into excitation channel 113A and detecting the photon at one of single photon detectors 115C and 115D. The photon paths are shown in dashed lines.

A Z measurement of qubit 111B may be similarly performed by configuring switches 117D, 117E and 117F and using single photon detector 114B and single photon detectors 115C and 115D.

FIG. 11D shows configuration of apparatus 110B for joint ZZ measurement on qubits 111A and 111B. In the FIG. 11D configuration:
switch 117D is controlled to connect single photon detector 115C to the part of excitation channel 113A to the right of switch 117D and to disconnect the part of excitation channel 113A to the right of switch 117D from the part of excitation channel 113A to the left of switch 117D.
switch 117E is controlled to connect single photon detector 115D to the part of excitation channel 113B to the right of switch 117E and to disconnect the part of excitation channel 113B to the right of switch 117E from the part of excitation channel 113B to the left of switch 117E;
switch 117F is controlled to connect the part of excitation channel 113A to the right of switch 117F to the part of excitation channel 113A to the left of switch 117F;
switch 117A is controlled to connect the part of excitation channel 113A to the right of switch 117A to the part of excitation channel 113A to the left of switch 117A; and
switch 117B is controlled to connect the part of excitation channel 113B to the right of switch 117B to the part of excitation channel 113B to the left of switch 117B.
   With this configuration, the correlated ZZ parity measurement of qubits 111A and 111B may be made by controlling photon source 114A to emit a photon into excitation channel 113A and detecting the photon at one of single photon detectors 115C and 115D. The photon paths are shown in dashed lines.

It can be appreciated that the apparatus of FIGS. 11A through 11D may be used as a building block for an extended photonic network which is configurable to make a Z measurement on any qubit in the network and to make correlated ZZ measurements on selected pairs of qubits in the network.

Those of skill in the art will understand that the functionality of apparatus 110A or 110B may be achieved with various arrangements of switches. In some embodiments, excitation channels 113 are parts of a dual-rail photonic network that interconnects all of a large number of qubits and is configurable using active switches to allow Z measurements to be made on single qubits or ZZ parity measurements to be made on adjacent pairs of qubits using active switches.

Apparatus as shown in FIG. 11A or 11B may be applied to perform deterministic parity measurements for knitting and/or fusion as described herein. Apparatus as in FIG. 11A or 11B may be integrated into a photonic network.

To perform quantum computing as described herein given a particular set of matter qubits, one must decide how to map qubits of the 3D cluster state to the matter qubits. It is convenient for the matter qubits to be arranged in two similar 2D arrays that overlap and are offset relative to one another. The 2D arrays may be on the same substrate. For example, half of the matter qubits may be arranged on the corners of tiled square or rectangular cells in a 2D array and the other half of the matter qubits may be arranged with one qubit located inside (e.g. at a center of) each cell of the 2D array. Each 2D array may be configured to contain the qubits of one layer of a 3D cluster state.

It is also convenient to select forms for pre-fabricated tree-like graph states that can be mapped onto the matter qubits in such a way that they can be tiled together to use the matter qubits efficiently.

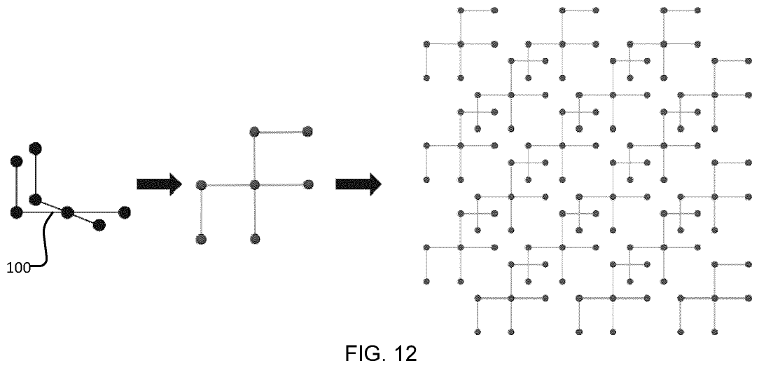

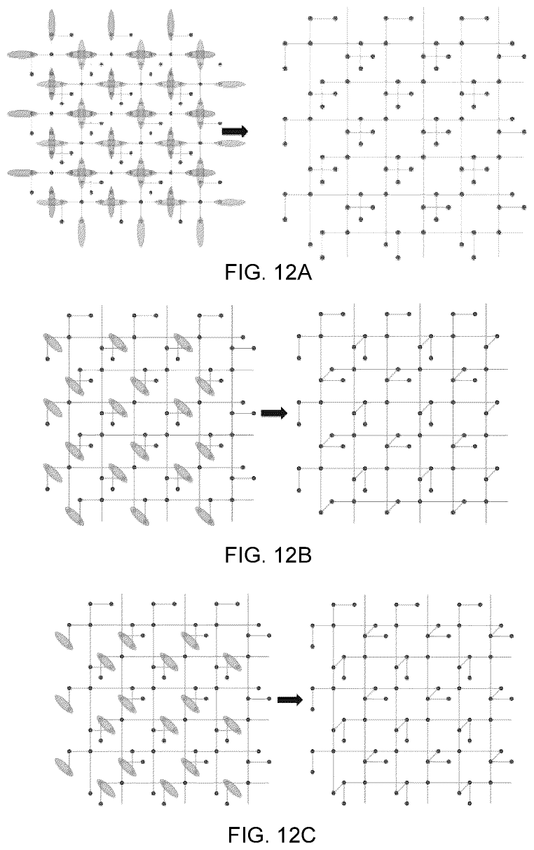

A unit 100 may be projected onto a 2D grid of matter qubits, for example, as shown on the center part of FIG. 12. Two overlapping tiled arrays of such units 100, for example as shown in the right hand part of FIG. 12, may be formed by knitting. On the right hand side of FIG. 12 qubits shown in lighter shading form one layer and qubits shown in darker shading form a second layer.

Adjacent units 100 in each tiled array may be fused together for example as shown in FIG. 12A to form a 2D graph state that constitutes a corresponding layer. The layers may then be fused together, for example as shown in FIGS. 12B and 12C.

When two layers have been fused together, one-qubit measurements may be made on the “lower” layer to carry out the quantum computing algorithm. Following the measurements, the “lower” layer is reset and re-fused to the other layer, but as the “upper” layer this time, and the cycle repeats. By iterating these steps, the 3D cluster state, as depicted in FIG. 8, is built and computed on.

### Photonic Circuit Architecture

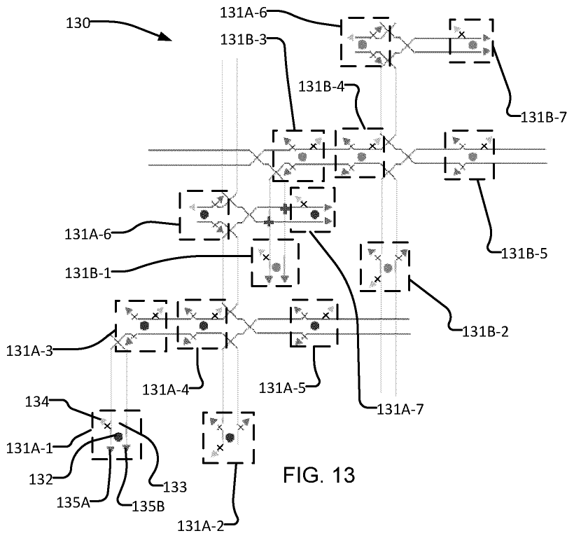

FIG. 13 shows an example physical layout 130 for a part of a photonic circuit. In this example, layout 130 can accommodate two units 100. The illustrated layout 130 may be tiled to make a photonic circuit of any practical size. Layout 130 comprises optically connected qubit blocks 131. Each qubit block 131 comprises one matter qubit 132 coupled to an optical resonator 133, a single photon source 134 and a pair of single photon detectors 135A and 135B. Single photon source 134 is tuned to the resonance of cavity 133 which closely matches a frequency associated with the |g [symbol] →|e [symbol] transition of qubit 132.

Layout 130 includes 14 blocks 131. A first group of seven interconnected blocks 131A-1 to 131A-7 supports a first 7-qubit unit 100 as described above. A second group of seven of the interconnected blocks 131B-1 to 131B-7 supports a second 7-qubit unit 100 as described above. Those of skill in the art will understand that the identical photonic circuit may be thought of as being made up of various layouts different from layout 111 and also that photonic circuits that differ in some respects from a photonic circuit made up of layouts 130 may be applied to practice aspects of the present invention.

A photonic circuit based on layout 130 may be operated to perform both single qubit Z measurements on any qubits 132 and two qubit ZZ measurements on any nearest-neighbour pair of qubits 132. Layout 130 may also be configurable to make multi-qubit Z parity measurements on three or more qubits (e.g. sending a single photon from a single photon source in one block 131 toward single photon detectors in another block 131 and setting switches in intervening blocks 131 to pass photons through the intervening blocks 131.

For the complete knitting and fusion process, it is also necessary to perform other operations on individual qubits such as:
Pauli X measurements,
Hadamard transformations,
   These may be performed with the assistance of optical and/or radio frequency components operable to manipulate the quantum states of individual qubits 132. For example, EPR or NMR pulses may be used as known in the art to implement a Hadamard gate where qubit 132 comprises an electron or nuclear spin respectively. When a measurement of Pauli X is needed, one can apply a Hadamard gate H to the target qubit before and after a single qubit Z measurement.

As mentioned above, the operations of the methods described herein may be coordinated by an automatic control system. The control system may be connected to control the operation of the photonic network (e.g. by setting optical switches to perform a deterministic entangling measurement on a selected pair of matter qubits, controlling a corresponding single photon source to emit a photon into a first waveguide coupled to the qubits and detecting the photon in one of a pair of corresponding single photon detectors as described herein.

The control system may additionally control a mechanism (e.g. control and measurement apparatus 18) for manipulating quantum states of individual qubits (e.g. by delivering appropriate radiofrequency or microwave pulses to selected matter qubits to implement quantum gates as is known in the art). For example, quantum states of individual matter qubits may be manipulated using techniques as described in K. J. Morse, R. J. Abraham, A. DeAbreu, C. Bowness, . . . and S. Simmons, Sci. Adv. 3.7 (2017) which discusses controlling states of qubits comprising singly ionized 77Se in bulk silicon using the resonant magnetic fields from a bulk microwave resonator. Control and measurement apparatus 18 may also or in the alternative apply other techniques such as those described in:
M. A. Fogarty et al., Nat. Commun. 2018; 9:4370 which describes using integrated circuits to generate local resonant microwave magnetic fields to manipulate single silicon-circuit-based qubits;
Volkov, M. Y., Salikhov, K. M. Pulse Protocols for Quantum Computing with Electron Spins as Qubits. Appl Magn Reson 41, 145-154 (2011). https://doi.org/10.1007/s00723-011-0297;
Quantum Entanglement and Information Processing, Volume 79 1st Edition Lecture Notes of the Les Houches Summer School 2003; Daniel Esteve Jean-Michel Raimond Jean Dalibard Eds, Elsevier Science, 2004, ISBN: 9780444517289;
Xin Zhang et al., Special Topic: Quantum Computing Semiconductor quantum computation, National Science Review 6: 32-54, 2019, doi: 10.1093/nsr/nwy153; and
The many other papers, patent documents and textbooks that discuss manipulating the quantum states of qubits and applying quantum gates to various kinds of matter qubits.

A control system may, for example, execute instructions to create layers of a 3D quantum graph state by building plural tree like graph states in a set of the matter qubits using knitting and then connecting the tree like graph states together and to another 2D layer of the 3D quantum graph state using fusion. In doing so, the control system may coordinate each step in the processes of knitting and fusion as described herein, including applying deterministic entangling measurements to pairs of the matter qubits. In some embodiments the control system causes these operations to be performed in parallel. For example multiple distinct tree-like graph states may be created at the same time.

In some embodiments the control system additionally coordinates making specified measurements of qubits belonging to a 2D layer of the 3D quantum graph state in selected bases to perform a one way quantum computing algorithm. In some cases some of the measurements are specified based on the results of prior measurements. In some embodiments the control system coordinates making measurements of multiple ones of the matter qubits of a 2D layer of the 3D cluster state at the same time or nearly the same time. In some embodiments the control system coordinates making measurements of all of the matter qubits that are providing a 2D layer of the 3D quantum graph state simultaneously.

Control systems used in some embodiments of the invention are implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a quantum computing device may implement methods as described herein by executing software instructions in a program memory accessible to the processors.

Photonic interconnects may be made with photonic components of types that are known and have been demonstrated in standard 220 nm thick SOI wafers at telecommunication wavelengths near 1.5 μm.

As mentioned before, the photonic platform used for the implementation can be silicon based, or based on a silicon-on-insulator (SOI) platform.

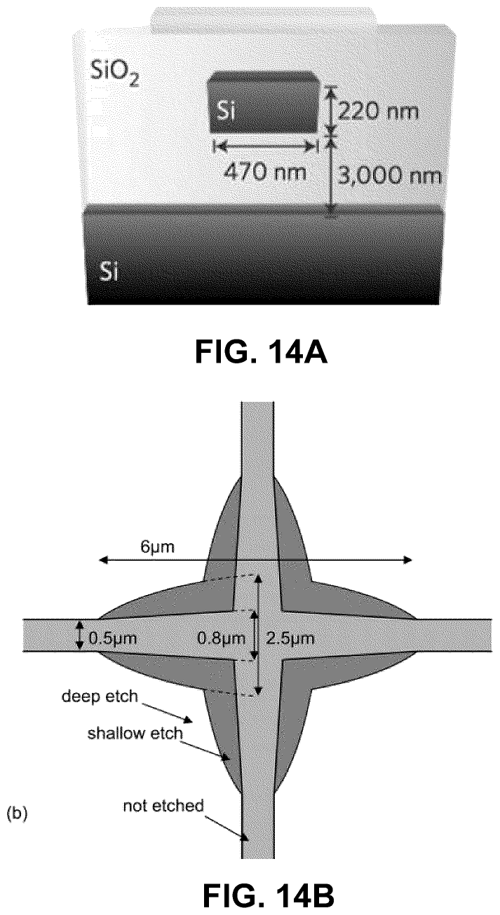

FIG. 14A is a cross section of a typical glass-cladded SOI waveguide. Light is confined in the 470 nm×220 nm silicon slab and can propagate in the in- and out-of-page direction. Waveguides of this type are described, for example in J. W. Silverstone, D. Bonneau, K. Ohira, N. Suzuki, . . . and V. Zwiller. Nat. Photonics. 8(2), 104 (2014).

FIG. 14B is a top view of a waveguide crosser, which is a photonic junction optimized to only allow light transmission in the left-right direction and the top-bottom direction. Waveguide crossers of this type are described for example in Y. Ma, Y. Zhang, S. Yang, A. Novack, . . . and M. Hochberg. Optics Express. 21(24), 29374 (2013).

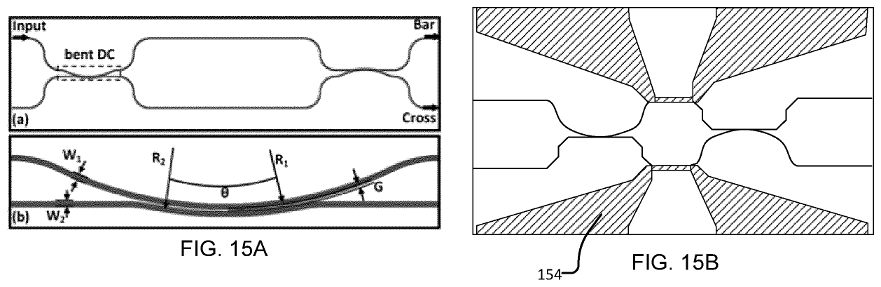

Active optical switches may be provided by Mach-Zehnder Interferometer (MZI) type switches. FIG. 15A shows a typical design for an MZI switch. The input is split into two light paths by a bent directional coupler (DC), and recombined at a second DC, exiting at two output ports (“bar” and “cross”). As light propagates through the two paths, the light accumulates phases respectively, and the phase difference between the two paths can lead to different interference conditions at the second DC. By controlling the phase difference, one can switch the MZI such that the light only exits at either the “bar” or “cross” port. An MZI type switch is described for example in S. Chen, Y. Shi, S. He, and D. Dai. Optics Letters. 41(4), 836 (2016).

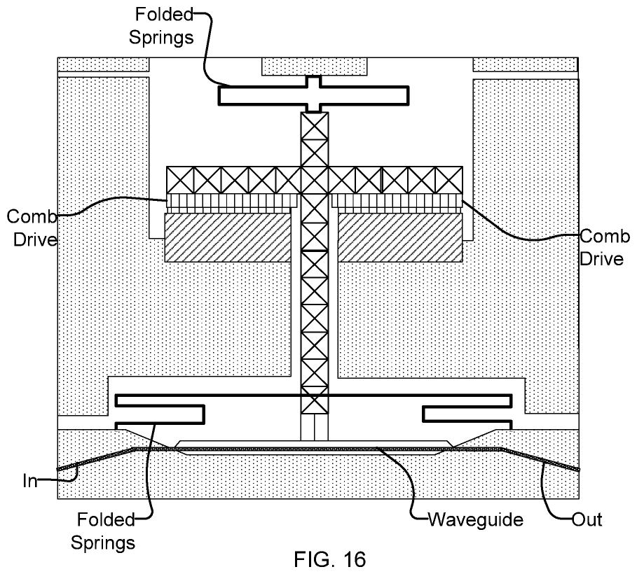

The phase difference control can be achieved by another component, the phase modulator. A metal heater 154 as shown in FIG. 15B is a type of phase modulator, through the thermal-optical effect. Another example of the phase modulators, shown in FIG. 16, is based on mechanical movement, and can be more cryo-compatible. A mechanical movement based phase modulator is described for example in P. Edinger, C. Errando-Herranz and K. Gylfason. The 32nd IEEE International Conference on Micro Electro Mechanical Systems 2019.

One of the most developed silicon-based single photon sources is the heralded four-wave-mixing source. The source utilizes the third-order nonlinearity of silicon. In a specific scenario, when silicon is “pumped” by a “pump” laser, it can absorb two pump photons and simultaneously emit a pair of single photons (the “signal” and the “idler”) which have different frequencies. Since this process is probabilistic, the idler photon is usually used to herald the signal photon as the single photo source.

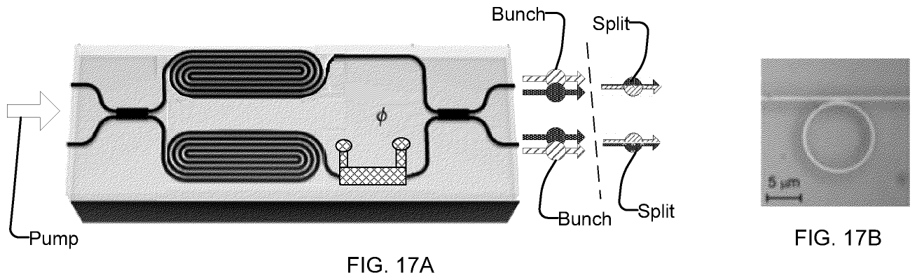

FIGS. 17A and 17B show two examples of heralded photon sources. The photon source shown in FIG. 17A has a spiral design, where the meander waveguide is long in order for a higher photon pair generation probability. Photon sources of this type are described in J. W. Silverstone, D. Bonneau, K. Ohira, N. Suzuki, . . . and V. Zwiller. Nat. Photonics. 8(2), 104 (2014).

FIG. 17B utilizes a ring resonator coupled to the waveguide (shown in the inset), where pump light is trapped in the resonator to enhance four-wave mixing. Photon sources of this type are described in S. Azzini, D. Grassani, M. J. Strain, M. Sorel, . . . and D. Bajoni, Optics Express. 20(21), 23100 (2012).

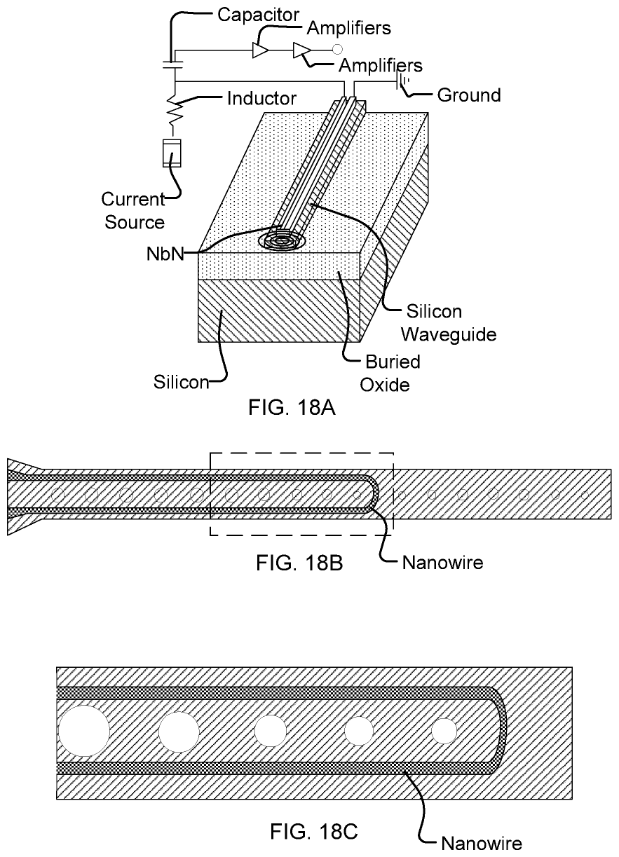

State-of-the-art single photon detectors are based on superconducting nanowires. Such detectors may be called superconducting nanowire single photon detectors (SNSPD). The detection mechanism is based on the phenomenon that a single photon absorption event can lead a current-biased superconducting nanowire to go normal. FIG. 18A shows a simple photon detector in which a superconducting nanowire (material NbN) is laid atop of a silicon waveguide, absorbing photons from the evanescent wave of the waveguide mode. Photon detectors of this type are described in W. H. Pernice, C. Schuck, O. Minaeva, M. Li, . . . and H. X. Tang. Nat. comm. 3, 1325 (2012). FIG. 18B shows another example single photon detector that employs a photonic crystal cavity to enhance the nanowire absorption photon. Photon detectors of this type are described in M. K. Akhlaghi, E. Schelew and J. F. Young. Nat. comm. 6, 8233 (2015).

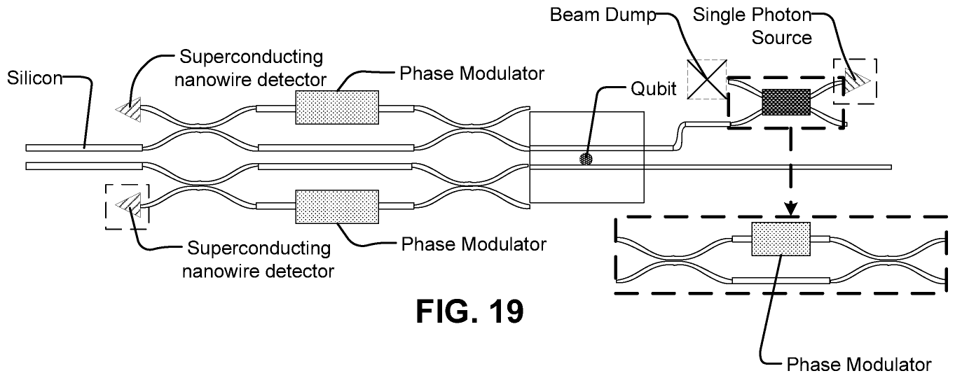

FIG. 19 illustrates a part of an optical circuit that uses components as described above to implement a quantum computing apparatus of a type described herein. The photonic circuit of FIG. 19 uses a spiral waveguide heralded source as a single photon source. The circuit also includes an asymmetric MZI switch to separate the signal/idler photons, and filters to select the desired photon pair frequencies.

This disclosure describes example architectures for fault tolerant universal quantum computation. Quantum computations may be executed using an elementary set of operations consisting of one-qubit operations and an entangling two-local Pauli measurement. An advantage of this computational architecture is that it is suited for distributed quantum computation. 3D graph states as described herein are a fault-tolerant fabric. Such graph states may be created with varying cell geometries and cell sizes, seamlessly connecting spatially separated nodes.

The references cited herein are hereby incorporated herein by reference for all purposes.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

While methods or processes include steps or blocks that are presented in a given order, alternative examples may have steps, or employ blocks, in a different order. Some steps or blocks may be deleted, moved, added, subdivided, combined, and/or modified to provide alternative or subcombinations. Different processes, steps or blocks may be implemented in a variety of different ways. While steps or blocks are at times shown as being performed in series, these processes or blocks may instead be performed in parallel, or may be performed at different times.

Some aspects of the invention are provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a switch, photon source, photon detector, resonator, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for performing quantum computations, the method comprising:
creating a 3D quantum graph state in a plurality of matter qubits arranged in a two-dimensional pattern on a substrate and connected by a network of photonic links, each of the matter qubits having first and second quantum computational basis states; and
performing quantum computations on the 3D graph state by measuring some or all of the matter qubits in corresponding selectable specified bases;
wherein:
the 3D graph state has a connected three-dimensional graph structure comprising plural vertices each associated with a corresponding qubit, the vertices connected by plural edges which indicate a structure of entanglement of the 3D graph state, each of the edges extending between a pair of the vertices;
the 3D graph state comprises a plurality of 2D slices in an order from a first one of the 2D slices to a last one of the 2D slices, each of the 2D slices comprising a plurality of the vertices and a plurality of the edges that are intraslice edges that connect vertices within the 2D slice in a 2D graph structure;
the edges of the 3D graph state include interslice edges that interconnect different ones of the 2D slices such that each of the 2D slices is connected by one or more of the interslice edges to one or more other ones of the 2D slices;
the method comprises configuring the matter qubits to provide a plurality of subsequent ones of the 2D slices, each of the plurality of subsequent ones of the 2D slices provided by a corresponding set of the matter qubits wherein:
configuring the matter qubits comprises entangling quantum states of matter qubits that correspond to vertices of the plurality of 2D slices that are connected by corresponding edges of the 3D cluster state by one or more steps comprising performing deterministic entangling parity measurements on pairs of the matter qubits; and,
performing each of the deterministic entangling parity measurements comprises:
configuring the network of photonic links so that each of the matter qubits in the one of the pairs of matter qubits corresponding to the deterministic parity measurement is coupled between first and second ones of the photonic links;
injecting a photon into the first photonic link; and
detecting the injected photon in the first photonic link or the second photonic link.

2. The method according to claim 1 wherein the 3D graph state is a 3D cluster state.

3. The method according to claim 1 wherein measuring some or all of the matter qubits in corresponding selectable specified bases is performed at different times for different ones of the 2D slices.

4. The method according to claim 3 wherein performing the quantum computations comprises measuring some or all of the matter qubits configured as one of the plurality of 2D slices that is earlier in the order and subsequently reconfiguring those matter qubits to provide one of the 2D slices that is later in the order.

5. The method according to claim 4 comprising simultaneously measuring a plurality of the qubits of the set of matter qubits configured as the one of the plurality of 2D slices that is earlier in the order.

6. The method according to claim 1 wherein, in the three-dimensional graph structure, at least one of the 2D slices comprises a first plurality of the edges connecting a first plurality of the vertices to form a first two dimensional cyclic graph having at least one closed cycle and another one of the 2D slices adjacent to the one of the 2D slices comprises a second plurality of the edges connecting a second plurality of the vertices to form a second two dimensional cyclic graph having at least one closed cycle.

7.-8. (canceled)

9. The method according to claim 1 wherein performing the deterministic entangling parity measurements comprises measuring the observable Zₐ⊗Z_{b} where Zₐ is the Pauli Z observable of a first one of the pair of matter qubits associated with the deterministic entangling parity measurement and Z_{b} is the Pauli Z observable of a second one of the pair of matter qubits associated with the pair of matter qubits associated with the deterministic entangling parity measurement.

10. The method according to claim 1 wherein:
the network of photonic links comprises a plurality of optical switches; and
configuring the network of photonic links comprises setting the optical switches to optically isolate sections of the first and second ones of the photonic links that are coupled to the matter qubits in the one of the pairs from other ones of the matter qubits.

11. The method according to claim 1 wherein:
the network of photonic links comprises one single photon source and first and second single photon detectors associated with each one of the matter qubits;
injecting a photon into the first photonic link comprises operating the single photon source that is associated with a first one of the pair of the matter qubits; and
detecting the injected photon in the first photonic link or the second photonic link comprises detecting the injected photon at the first single photon detector or the second single photon detector associated with a second one of the pair of the matter qubits.

12. The method according to claim 11 wherein the matter qubits are arranged in a first plane and one or more of the single photon sources or one or more of the single photon detectors are located out of the first plane.

13. The method according to claim 11 wherein each of the matter qubits is coupled to an optical cavity having a resonant frequency corresponding to a characteristic energy associated with a dipole-allowed transition from one of the first and second quantum states of the matter qubit to a higher-energy excited state of the matter qubit and the optical cavity is coupled between two of the photonic links and the single photon has a frequency substantially equal to the resonant frequency.

14. The method according to claim 13 wherein the characteristic energy corresponds to a frequency on the order of 100 THz.

15. (canceled)

16. The method according to claim 1 wherein each of the matter qubits is coupled to an optical cavity having a resonant frequency corresponding to a characteristic energy associated with a dipole-allowed transition from one of the first and second quantum states of the matter qubit to a higher-energy excited state of the matter qubit and the optical cavity is coupled between two of the photonic links.

17. The method according to claim 1 wherein configuring the matter qubits to provide a plurality of adjacent ones of the 2D slices comprises configuring the matter qubits to provide a plurality of 2D quantum graph states and generating edges that join vertices of the 2D quantum graph states.

18. The method according to claim 17 wherein each of the 2D quantum graph states is tree-like.

19. The method according to claim 17 wherein the 2D quantum graph states each have the same graph structure.

20. The method according to claim 17 wherein the 2D quantum graph states each comprises a graph consisting of a vertex with four 1 D branches extending from the vertex.

21. The method according to claim 20 wherein two of the four 1 D branches have one vertex each and two of the four 1 D branches have two vertexes each.

22. The method according to claim 17 wherein each of the 2D quantum graph states has a 2D tree-like graph structure and the method comprises:
initializing a quantum state of one of the matter qubits corresponding to an initial vertex of one of the quantum graph states; and
sequentially adding vertices to complete the 2D tree-like graph structure of the 2D quantum graph state by, for each of the added vertices:
preparing a corresponding one of the matter qubits that is not already included in any of the 2D quantum graph states in the state |+ [symbol] , where |+ [symbol] is the eigenstate of the Pauli operator X with the eigenvalue+1;
measuring the correlated observable Zₙ⊗Zₙ₊₁ where Zₙ operates on one of the matter qubits corresponding to a vertex of the 2D tree-like graph structure under construction and Zₙ₊₁ operates on the matter qubit corresponding to the vertex being added and ⊗ is the tensor product;
conditionally, if the measurement of the observable Zₙ⊗Zₙ₊₁ yields a value of −1, applying the Pauli operator Xₙ₊₁ to the matter qubit corresponding to the vertex being added; and
applying a Hadamard gate Hₙ₊₁ to the matter qubit corresponding to the vertex being added.

23. The method according to claim 17 wherein generating at least one of the edges that joins one of the vertices of a first one of the 2D quantum graph states to one of the vertices of a second one of the 2D quantum graph states comprises fusing the first and second 2D graph states by:
measuring the correlated observable Zₐ⊗Z_{b} where Zₐ is the Pauli Z operator that acts on the matter qubit corresponding to one vertex of the first 2D quantum graph state and Z_{b} is the Pauli Z operator that acts on the matter qubit corresponding to one vertex of the second 2D quantum graph state; and
subsequently performing the measurement
cos(α)Xa+sin(α)Ya
or the measurement
cos(α)Xb+sin(α)Yb
where α is any angle, Xa is the Pauli X operator that acts on the matter qubit corresponding to one vertex of the first 2D quantum graph state and Xb is the Pauli X operator that acts on the matter qubit corresponding to one vertex of the second 2D quantum graph state; Ya is the Pauli Y operator that acts on the matter qubit corresponding to one vertex of the first 2D quantum graph state and Yb is the Pauli Y operator that acts on the matter qubit corresponding to one vertex of the second 2D quantum graph state.

24. The method according to claim 23 wherein the measurement is Xb.

25. (canceled)

26. The method of claim 17 wherein configuring the matter qubits to provide the plurality of 2D slices comprises:
fusing a first plurality of 2D quantum graph states together to form a first 2D sheet;
fusing a second plurality of the 2D quantum graph states together to form a second 2D sheet; and
fusing the first 2D sheet and the second 2D sheet.

27. The method of claim 17 comprising simultaneously configuring the matter qubits to provide two or more of the plurality of 2D quantum graph states.

28. The method according to claim 1 wherein the plurality of 2D slices all have congruent graph structures.

29. The method according to claim 1 wherein at least some of the plurality of 2D slices comprises a polycyclic graph structure.

30. (canceled)

31. The method according to claim 30 wherein the donor qubits comprise impurity atoms implanted in the substrate.

32.-39. (canceled)

40. The method according to claim 1 wherein the set of matter qubits configured to provide each of the plurality of subsequent ones of the 2D slices forms a regular array on the substrate and the regular arrays corresponding to different ones of the plurality of subsequent ones of the 2D slices are offset relative to one another in a direction parallel to a plane of the substrate.

41. (canceled)

42. The method according to claim 41 wherein the matter qubits comprise first and second sets of the matter qubits and performing quantum computations on the 3D graph state comprises measuring some or all of the matter qubits of the first set of matter qubits in alternation with measuring some or all of the matter qubits of the second set of matter qubits.

43. The method according to claim 42 comprising, after measuring some or all of the matter qubits of the first set of matter qubits:
initializing the matter qubits of the first set of matter qubits;
configuring the first set of matter qubits according to the 2D graph structure; and
fusing the first set of matter qubits to the second set of matter qubits.

44. The method according to claim 43 comprising, after measuring some or all of the matter qubits of the second set of matter qubits:
initializing the matter qubits of the second set of matter qubits;
configuring the second set of matter qubits according to the 2D graph structure; and
fusing the second set of matter qubits to the first set of matter qubits.

45.-87. (canceled)

88. A control system for a quantum computing apparatus comprising a data processor and stored instructions executable by the data processor which, when executed cause the data processor to perform a method according to claim 1.

89.-90. (canceled)
